(19) United States
(12) Patent Application Publication
(10) Pub. No.: US 2009/0162826 A1
(43) Pub. Date: Jun. 25, 2009

(54) Mass Customization Method for High School and Higher Education

(76) Inventors: Mohammad B. Ayati, Los Angles, CA (US); Susan Carol Curzon, Los Angles, CA (US)

Correspondence Address: MOHAMMAD B. (TAHER) AYATI, 12652 CLASSICS DRIVE, LOS ANGELES, CA, 91344, US

(21) Appl. No.: 12/269,057

(22) Filed: Nov. 12, 2008

Related U.S. Application Data
(60) Provisional application No. 60/990,181, filed on Nov. 26, 2007.

(51) Int. Cl. G09B 7/00; G06Q 10/00; G06Q 90/00

(52) U.S. Cl. 434/323; 434/353; 705/1

(57) ABSTRACT

MCMEd is an institutional level Business Method claim for a new design of the structure and processes of learning to facilitate mass production/customization of High School and Higher Education.

The present education system operates in shop-mode, in which the single teacher is in charge of the complete cycle of education. No technology so far, including on-line and distant education has changed the shop-mode of the learning process.

MCMEd is a large-scale distributed business method that offers education in a customizable hybrid mode: online and in class in flexible combinations that maximize student's actual learning outcomes. In MCMEd design, MCMEd Central consolidates, coordinates, and computerizes the repetitive and duplicated activities, saving magnitudes, while producing higher and consistent quality content, exams, and grading. MCMEd further reduces duplication by adapting a modularized-structure of knowledge. MCMEd affiliated schools are outlets which can keep students on-course to maximize their learning potential.

### I. INTRODUCTION

Mass Customization Method of Education, (MCMEd) is an Institutional level Business Method. It is a new redesign of the structure and processes of learning to facilitate mass production/customization of High School and Higher Education.

MCMEd is a large-scale distributed business Method that offers serious education in a hybrid mode: online and in class in adjustable combination that maximizes the student's learning outcomes. It is a system designed for perpetual cost cutting and quality enhancement. MCMEd is largely designed for undergraduate education; however, its capabilities extend from high school education to coursework part of graduate programs.

Design, by definition is an arrangement. In MCMEd, certain processes and functions are taken as they are in the present HH-Ed system, and some are modified to enhance the integration of the system. As shown in this document, most features of the present HH-Ed are half backed measures, and more significantly, they have loose connections between them. In contrast, MCMEd's feature are fully developed, and more significantly, they are cohesively tied together to make an efficient and effective Mass Production and Mass Customizable HH-Ed system.

As stated by the United States Patent Office, “Utility patents may be granted to anyone who invents or discovers any new and useful process, machine, article of manufacture, or composition of matter, or any new and useful improvement thereof;” In this document, we submit evidence that MCMEd is a significantly improved and offers a significantly useful education process system for high school and higher education.

Design Target: In the US, there are some 4500*¹ degree granting institutes of higher education. In FIG. 1, the Actual Learning Outcome, the sum of Learning Potential, and Cost per Student per Course are plotted on subjective scales of Institution Rank and the Average Quality and Rigor of learning in various institutions. The message of this figure is to visualize two enormous wastes in the system: one is the wasted resources: the difference between the collective Actual Learning Outcome that we get vs. the cost we pay for education. The other waste is the difference between the actual vs. potential learning capabilities in our students*². At the top, some 5% or so, we have the likes of Harvard, Stanford, and other quality but less famous institutions. These top institutions produce high quality learning outcomes, though at very high costs. Even at the top, there is more potential, argues Derek Bok, the President Emeritus and Research Professor at Harvard University [1]. This small percentage of top institutions represents American education, especially to the international community. They camouflage what is beneath. Below-that-top, the quality and rigor dive down drastically, but, the cost does not come down proportionally; meaning that throwing money at a structurally flawed system cannot solve this collective problem. This below-the-top majority of institution is the focus of MCMEd, which in this document, is referred to as ‘the present system,’ or ‘the present education.’ MCMEd's design is to significantly reduce these wastes. *¹ According to the Census Bureau, [www.census.gov/population/www/socdemo/educ-attn.html], there was 4314 degree granting institutions in year 2006.*² One can find master teachers in every school and self-motivated students in every class who take advantage of every opportunity to advance learning; however, in designing this education system, maximizing the collective yield is the objective.

The business structure and process design features of the MCMEd are derived from (a) analysis of the inadequacies in the present system, and (b) opportunities offered by the available large scale computer and communication technologies. Therefore, comparisons of MCMEd's features with the Prior Art are imbedded in each section.

There are two intertwined structural flaws in the present system:

A) Shop-mode operation.

B) A Wrong accountability system
A) We have nearly a century of experiences with mass production and a couple of decades in mass customization; yet education operates in pre-industrial shop-mode operation. In shop-mode, the shop operator operates and manages every aspect of the production process. The major distinction of mass production from shop-mode operation is the orchestration of tasks within and amongst teams of professionals and extended automation of the core processes. The result is producing products with consistent quality at lower cost.

As depicted in FIG. 2, in any production, three variables are important: cost, quality, and consistency of the product. For example, take the production of the automobile; before Henry Ford's manufacturing system, cars were produced in shops with no established consistent quality control measure, depicted as products A, B, and C on FIG. 2. Products B and C, for example, may even have the same average cost and average quality, but B has a higher variability—the statistical risk factor. Product B has higher level of inconsistency, which may be confused and deceived by the shop that showcases a few high quality cars or advertise for lower cost. In such cases, the deceptive marketing plays a bigger role in the success of the business than substance of the product—at the expense of the customers. The transformation of automobile production from shops to the assembly lines reduced the cost, but more significantly, reduced the variability in the product quality. In time, what comes out of these assembly lines (M,N,P, . . . X, Y products) are increasingly more consistent; therefore, the consumer has an easier decision making on the two dimensional Cost-Quality product space; and the producer has to compete within the two dimensional Cost-Quality product space. From 1914 on, the competition between manufacturers has caused higher quality at less cost. The reliability and usability of the products have been increasing since; and customers collectively have been benefiting.

No matter, how we feel about the negative economical and environmental side-effects of automobile, one thing is certain: the approach to mass production has resulted in consistency and evolutionary betterment of the product. From feeding and clothing of billions to moving about vast territories, fast and safe, to access to information, all made possible because of our ingenuity to produce goods and services in mass for the masses. Mass production, however, has a fundamental flaw: from mass production, we get a ‘run-of-the-mill;’ it does not respond well to the uniqueness of the individual's wants*¹. To remedy this flaw, the system has evolved to mass customization. Mass customization is a form of mass production, in which the product can be adjusted to the wants of the buyer. Service industries, in particular, are largely built on the concept of customization. Now mass customization is being adopted in production of some good, e.g. computers, as well. *¹ For these reasons, auto-manufacturing is not a good analogy for mass customization of education, In terms of impact, mass customization of education would be analogous to the transformation of theater to cinema and television, which made mass access possible.

In education, the single teacher works as the shop operator, albeit with others' help and modern tools. As depicted in FIG. 3, the teacher develops, delivers, manages a course, and then judges the learning outcomes of individual students by assigning grades. The teacher is the researcher, content provider, deliverer, exam maker, exam proctor, and the grader.

It is true that a large administrative and support system, including a large system of computer and communication, supports the teaching function, yet the work of the teacher, which is at the core of the business, remains in shop-mode. No technology so far, including on-line and distance education, as potentially useful as they are, has changed the shop-mode of the learning process.

This is a severely inefficient system with inconsistent quality: The same course is produced and delivered by many faculty members, term after term at significant costs.

Speaking statistically, at the core, the present education, on the average, is a low return and a high risk enterprise*¹:
i. The present system is low return because the quality of course content and coverage, on the average, is mediocre; for the primary reason that, more than ever before, the knowledge base in every subject advances faster than a single teacher can catch up. Moreover, for a generation whose interest and attention span is shaped by the entertainment industry the course content, in most cases are not attractive. Listening to ordinary lectures and doing homework whose immediate usefulness is not obvious, cannot hold students' interest for long. The captivating teaching ability of the master teachers and attention of the high caliber students are more of the exception than norm; the rest are sitting bored [2] or busy surfing the web or engaged with their emails [3].
ii. The present system is high risk because the course coverage and deliveries are inconsistent: varying considerably from class to class, depending on the teacher's knowledge, ability, mood, commitment, and interests. *¹ Statistically, risk is the representation of the variability of the outcome.

The basic question is how to apply mass customization to education. Education is a complex industry; it produces goods: content packages called courses; and it produces services when those courses are delivered to students and help the students to go through the learning processes. Application of a mass production/customization system to education, nevertheless, is neither immediate nor trivial, because the raw material is the student's learning potential—a non-physical, which has to go through a non-physical and highly complex process.

The present education cannot take full advantage of the immense potential of the available large scale computer and communication systems to bring more automation into the core processes of education; because in the shop mode, technology is used only as tools and in support functions, not at the core process. In mass production/mass customization of education, the full power of the available technology is employed in its core processes.

Therefore, the design mission of MCMEd is to create education institutions that are high return and low risk. That is:
(a) Within the two dimensional Cost-Quality product space, provide significantly better learning outcome.
(b) Provide low risk in the sense of significantly more consistent quality of the learning outcome.

Design, by definition is an arrangement. As is the case in most, if not all, manufacturing system redesigns, in MCMEd, certain processes and functions are taken as they are in the present HH-Ed system, and some are modified to make an efficient and effective Mass Production and Mass Customizable HH-Ed system. What is new and unique in MCMEd is the design—the arrangements with:
a) a modular approach to knowledge base,
b) a different Man-Machine division of labor,
c) a cohesive and consistent flow between the subsystems of the learning process, and
d) a robust system of accountability and total quality control.

The result is a coherent learning system and a learning institution in which:
1. utilization of educational resources are optimized,
2. students' learning potential are enhanced,
3. consistency of the quality of the offered learning services is preserved throughout the system, and
4. economy of scale can be achieved without loss of quality, no matter how large the institution gets.

In section II, we describe the organizational structure, and in section III, the features of Mass Customization Method of Education.
B) In section III.5.1 and its sub-sections, we show how education suffers from a confused and counterproductive accountability system. In short, in the present system, enrollment is the only serious objective variable there is. Of course, enrollment is the key to survival for any educational institution; what is lacking, however, is accountability of learning outcomes in most institutions. Enrollment pressures are exerted upon the teacher and enforced through student evaluations—the de-facto measure of teacher performances to which the teachers' jobs depend. In sections III.5.2, and VI.2, we have explored the causes of degradation of education and inflation of empty diplomas. These are built-in policies which unintentionally sabotages the achievable learning outcomes for almost all students. The wrong accountability, more than any other damage, stifles motivations. Bringing together the best of educational resources will not make a quality institution if students are not or cannot be motivated.

MCMEd's robust system of accountability:
utilizes objective measurements for the outcome of each subsystem,
makes subjective measurements more verifiable,
removes policies that inherently create conflict of interest and in part sabotages the learning process,
prevents abuses by all parties involved: Students cannot get undeserved grades and empty diplomas. Teachers cannot compromise on the course coverage, and
allows the option of variable-charge for educational services.

As the result, the performance of each MCMEd affiliated school is measured objectively; and the quality of the MCMEd institution as a whole becomes verifiable and auditable. Therefore, the consumer of education (the students, parents, and the society) would know what education value they get for the time and the money they spend in that school.

In section III.6, we show how MCMEd's robust accountability system can move the education system toward maximize learning outcomes across the system.

In describing this Business Method, every aspect of MCMEd is compared with the present HH-Ed as the ‘prior art.’ Education design by nature is quite complex; therefore, in the body of this document, pages 12-50, the comparisons are kept at a minimum to prevent cluttering the design issues. However, further comparison issues, yet quite significant, are elaborated in section VI, pages 51-62.

In the presentation of this Business Method, we will use the terminology and the conventional approach of the discipline of Production Systems as applied to HH-Ed.

### II. ORGANIZATIONAL STRUCTURE OF MCMEd

MCMEd creates mass production/customization by orchestrating educational tasks between Human and Computer, as well as amongst and within teams of faculty. Such a system can take full advantages of the immense potential of the available large scale computer and communication technologies in the core process of learning.

MCMEd combines mass customization method of production with a distributed (franchised) business structure. A MCMEd institution is composed of MCMEd Central, and a set of affiliated schools:

FIG. 4 represents the orchestration of academic and administrative teams in the MCMEd's large scale, distributed educational system: The core in this figure represents the MCMEd Central, in which (a) teams of faculty do research, produce content in several format; (b) MCMEd's intranet delivers the content; (c) teams of faculty make the exams and their assistants proctor exams; and (d) MCMEd's intranet sparse the responses and deliver them to the grading network and collects the grades.

Affiliated Schools are depicted as orbiting the MCMEd Central; they receive the content, deliver them to students, coach, train, and motivate the students, keep them on course, monitor their progress, and prepare them to take the course comprehensive exam.

### II.1. MCMEd Central:

With the exception of class management and necessary contacts with students, other academic functions, which traditionally have been the responsibility of the teacher, are moved to teams of highly qualified academics and professionals at the MCMEd Central. The combined knowledge, skills, and experiences of team members replace limited knowledge, experiences, and interest of the traditional single-handed teacher.

MCMEd combines mass customization method of production with a distributed business structure. In this system, production of the course materials, exams and grading are done centrally. Therefore, as the system grows in size, cost per student per course decreases. The quality of course materials, exams, and grading system improves as more resources become available at the MCMEd central. The improved course materials, exams, and grading services are then distributed to all MCMEd schools, where students receive education in small classes and with more individualized attention.

There are two sets of operations in MCMEd Central: Academic Operations and Administration Operations:

A. Academic functions include:
1. Research Activities,
2. Design and development of academic and professional programs, curriculums, and courses,
3. Delivery of the programs to the affiliated schools,
4. Production of exams,
5. Arrangement and quality control of the Grading Network.

B. Administrative operations include:
1. Testing Administration:
   a. Arranging testing facilities. Testing facilities are computer labs fortified with security measures.
   b. Arranging security during the exams.
   c. Scheduling the exams,
   d. Conducting/proctoring—at testing facilities inside or outside of the affiliated schools.
2. Research Support System includes:
   a. Research Library (physical and virtual)
   b. Collaborative Systems—development and maintenance,
   c. Research support staffs and facilities such as laboratories, editorial, statistical, technological, etc.
3. Records and Repository Administration is in charge of:
   a. The catalog of ‘fields of study,’ programs, curriculums, and courses,
   b. The system's Knowledge base (the Course Knowledge Base, CKB, and the course Practice Base, PB, for all available courses)
   c. Test Databases,
   d. Management of or access to MCMEd schools' admission and enrollment records,
   e. Students' Grades,
   f. Records of faculty contributions to various operations.
4. Supporting business administration: (Purchasing, Accounting, HR, etc.)

### II.2. MCMEd Affiliated Schools:

MCMEd schools are physical, virtual, and most likely hybrid outlets that deliver courses and programs to students. The main mission of the school, as the training ground, is to maintain the student on-course. Relieved from repetitive academic operations, faculty can concentrate on helping individuals and groups of students to achieve their maximize potential.

The activities of the schools are streamlined and focused; thus, the resources needed to open and maintain schools are minimized. This arrangement, therefore, expands the general access to high quality education.

MCMEd schools have the following sub systems:
1. Admission, registration, and enrollment,
2. Instructional and tutoring facilities:
   i. Physical and virtual class sessions,
   ii. In-school and distant Helpdesk system,
3. Local Library and Learning resources connected to MCMEd Central Library System and Learning Resources
4. Laboratories and Computer Labs (fortified as testing facilities when needed.)
5. Faculty affairs.

Supporting business functions: (e.g. Purchasing, Accounting, HR, etc,) at both MCMEd Central and MCMEd schools, are the same as in standard franchised operations; and their adaptation to MCMEd involves operational issues not structural; therefore, we see no need for further elaboration on them in this document.

### III. FEATURES AND PROCESSES OF MCMEd

The Skeleton of educational processes is composed of the following subsystems and sub-processes, as depicted in FIG. 5:
1. Extracting the Course Knowledge Base (CKB) from the broader well-structured System's Knowledge Base of interest to the institution.
2. Creating the related set of review questions, problems, analysis of cases, and/or design and development practices to foster active learning [4] of the course content, the CKB. (We will refer to this set as “Practice Base, PB.)
3. Delivering the content.
4. Guiding and coaching students' practices to learn the course content.
5. Creating and administering the quizzes and examinations; and
6. Evaluating each student's performances in the course and assigning a grade.

Any educational system has these same sub-systems. In the following sections, we will show how these features are redesigned within the MCMEd organization described in section ii.

### III.1. Course Knowledge Base:

Development of Courses Knowledge Bases in MCMEd is based on the logic of two fundamental concepts: knowledge categories and the modular structure of knowledge.

### III.1.1. Knowledge Categories

The knowledge and skills that HH-Ed students have to master are structured and therefore, can be captured, stored, and disseminated by computer and communication technology. To clarify this position, we need to look at the spectrum of knowledge. As depicted in FIG. 6: Three layers of knowledge are identified: The highest level of knowledge is the most ambiguous layer, which is the subject of original research. The next layer is somewhat known, often experimental, knowledge and skills.’ The third layer is the well-structured knowledge and skills. The main struggle of human race is against the unknown. At the forefront of this struggle, first line researchers gradually bring pieces of the unknown into the somewhat-known. Doctoral research programs are designed to bring fresh troops into this frontier. Masters' Degree programs are setup to bring pieces of somewhat known into known and often applicable territory. Finally, teachers and textbook authors make the known into well-structured knowledge to nurture high school and undergraduates learners.

Up until the early 20^{th} century, structured knowledge and skills were limited and thus could fit into high school education. Higher education was established to search for less known and the unknown. The realm of well-structured knowledge has been expanding since. Now, not only high school curriculum, but also nearly all course-work at baccalaureate and early graduate level fit into well-structured knowledge and skills.

At the post-graduate research level, the mission is no longer the transfer of well-structured knowledge and skills. There is no well-structured knowledge at this level; and the job is not to transfer but to search into the less known and the unknown. Therefore, the nature of academic pursuit at this level requires different structure and processes.

With this logic, MCMEd is applicable to high school and higher education up to, but not including, the graduate research level. The differences between high school and higher education are operational, not structural. We realize the validity and legitimacy of the presently established gate-keeping and diploma milestones; and that educational needs of students require different programs and different blends of resources as they mature academically and move on to higher levels. However, resource allocation and diploma milestones are operational, not structural, issues. MCMEd can work with present diploma milestones, as well as with combined high school and baccalaureate level programs. The benefit of the latter alternative is discussed in section IV.

### III.1.2. Modular Structure of Knowledge:

In many industries, and in particular in electronic, computer, and communication technologies, the concepts of modularity and reusability have produced phenomenal success. A closer examination of HH-Ed subject knowledge reveals significant overlap among different courses. For example, the concept of ‘time value of money,’ as a course module is repeated in multiple courses in Economic, Finance, Accounting, Project Management, Decision Support Systems, etc. Throughout the HH-Ed curriculums, hardly any module is not repeated in multiple other courses albeit with different examples, application, and flavor.

In the present HH-Ed system, thousands of faculty-hours are spent in the preparation and delivery of the same modules term after term, in the same course and across the programs and curriculums, by the same teacher or by different teachers. This is a laborious, repetitive, expensive, and wasteful repetition.

(What we discuss here is the wasting of educational resources in repetitive production of the same course modules in the present shop-mode operations. For the students, however, the repetition and seeing the modules across disciplines, as accommodated in MCMEd, are essential parts of the learning process.)

### III.1.3. Production of Course Knowledge Base (CKB):

In MCMEd, the System's Knowledge Base is developed through identification and production of modules. Programs and curriculums are then developed through the assembly process of relevant recorded modules.

Highly qualified faculty teams, connected to the network of specialists in various fields, define the fields of studies, which include traditional as well as potential interdisciplinary fields. Next, they define and catalog the hierarchy of fields, subjects within the field, and modules within a subject.

FIG. 7 depicts the relationship of modules, subjects, courses, and programs. The relationship of Module and Subject is many to many; that is a subject is composed of one or more modules; and a module may be incorporated in more than one subject. The same (many to many) relationship exists between subjects and course, and between courses and programs.

Learning outcome objectives are defined for each module, subject, course, and program.

Modules are produced in various formats as appropriate to the subject: text, graphics, recorded video of the lectures, animation, simulation, game, and debate. The beta versions of the modules, as well as course and program proposals, are sent to the wider group of MCMEd faculty for feedback and quality control.

Related to each module or a subject, there is an indispensable set of review questions, problems, analysis of cases, and design practices that we referred to as Practice Base (PB) which facilitates active learning. Creating the PBs is discussed in next section.

The CKBs, the PBs, the totality of the MCMEd's knowledge base (KB), the curriculum, and programs are periodically updated by revising the existing modules, courses, and programs, and adding new ones.

While a module has a common core, alternative versions of the module, and its associated PB elements, are created to fine-tune the module to the subject and in turn to the field. Moreover, due to centralization and large-scale operations, MCMEd can afford to have learning-styles experts guide the production of alternative modules and their related PB items to accommodate different learning styles. The present HH-Ed cannot afford accommodating alternative learning styles in so many classes in shop-mode operations.

Through modularity and reusability, mass customization is achievable: Courses and programs are assembled quickly and at significantly lower costs. Moreover, customizing courses or programs to local needs can be accomplished quickly and with little extra costs.

The richness of the system is defined, in part, by the variation and quality of alternative modules that are incorporated in the system.

### III.2. Practice Base (PB):

When posed with questions, problems or a design, the student's mind shifts to active mode to produce a response. This is when the learning deepens. Active learning puts the students at the center of learning responsibility. In this position, students seek help from the instructor, rather than the instructor running after the students and trying to make them learn. In the process of active learning, students first internalize, then expand and evolve their ‘understanding’ of the subject. Support for active learning, therefore, becomes as essential as the knowledge base, but plays a more important role in educating the young.

The support system for active learning in the present HH-Ed, on the average, is severely limited and expensive: First, students' interactions with the faculty regarding questions and answers, case/projects analysis or design are limited to the class time and office hours. Second, as we discuss in section III.3.1, in the present system, many students may pass the course undeservedly without completing the necessary practice set.

MCMEd provides solutions for both deficiencies mentioned above: First, MCMEd's PB significantly expands the support system. Second, the structure of MCMEd's course comprehensive final test and its impartial grading system eliminates any hopes that an unprepared student may have to pass the course without learning what is in the practice set of the course; section III.3.2 explains how.

MCMEd's PB is practically an inexhaustible source of learning, available online 24/7. The PB includes numerous updated objective and subjective items. Selected Response or so called objective questions (True/False, Multiple-Choice, Matching word and phrases, Fill-In-the-Blanks, etc.) are valuable in introductory courses, where learning a large number of new terminologies and broad survey of a field is the goal. In MCMEd, access to practice items, getting hints or guidance, and checking the answers all are done online; and two-way hyperlinks connect them to the topics in the relevant course modules.

The limitation of Selective Response questions, however, is that students practice only a limited set of reactive skills.

Subjective and expressive exercises are needed to deepen students' understanding of the subject and hone their proactive skills. Essay questions make students practice their reasoning, articulation, organization, and professionalism in presentation. Problem solving questions and debates make students exercise their power of critical thinking, analysis, exploration of alternatives, establishment of criteria, and articulation of the choice. Case analysis and design questions practice students' skills of using methods of exploring requirement, analysis of inadequacies, design methodology, searching for available components of a design, and assessing feasibility and optimality of the creative elements. This segment of course practices are more important by far than the Selective Response segment; yet, in the present system, it is more subject to compromises, simply because of (a) the limited opportunities for student interaction with the faculty and (b) expecting that most of the exams are of Selected Response type.

In MCMEd, the emphasis is on the subjective and expressive exercises. The first line of support for this type exercises is MCMEd's online PB, which provides many guidelines, templates, and samples for each item. Each item is doubly hyperlinked to the relevant course modules. Modules are also hyperlinked to other relevant module in the system, as well as referenced to copyrighted material outside the system. The second line of support is provided in the Affiliated School. The core activity of instructors and tutors at an Affiliated Schools is to help students to navigate through the CBK/PB and provide feedback on their subjective exercises, in person or through a live or remote helpdesk system.

In the next section, we explain how the PB prepares students for final exams. The PB in conjunction with the prospect of an upcoming course comprehensive final exam moves the student to the center of learning responsibility and mobilizes their learning motives and potential.

### III.3. Delivering the Content:

As discussed in the previous sections, MCMEd's system content (the sum of Course Knowledge Bases and their associated Practice Bases) are provided by the MCMEd Central trough the institution's intranet with proper access controls. Instructors at MCMEd Affiliated schools are responsible for helping the students to learn the provided content; they can add to the provided content if it helps the students, but they cannot ignore any part of the content because students will face a test that will cover the content comprehensively. The test and grades will be created and administered by the MCMEd Central independent of the instructor.

### III.4. Guiding and Coaching Students to Learn the Course Content:

Students who are enrolled in a course session offered by a MCMEd Affiliated School can access the content online. Instructors in these schools help the enrolled students to navigate the CKBs/PBs and help them with practices and additional explanations of the content when needed. In this arrangement, the student and the instructor know that the upcoming course final exam coming from the higher authority (the MCMEd Central) covers most, if not all, the main and supporting points throughout the course; therefore, in this system, it will be the student who will demand full coverage of the course from the instructor. This is in contrast to the present system as explained in section VI.1.

Sub-processes 5 “Creating and administering the quizzes and examinations” and 6 “Evaluating each student's performances in the course and assigning a grade,” listed under section III are quite intertwined. Therefore, in the following sections both sub-systems are addressed together. In the section III.5, the flaws of the present system are analyzed and in terminologies and broad survey of a field is the goal. In MCMEd, access to practice items, getting hints or guidance, and checking the answers all are done online; and two-way hyperlinks connect them to the topics in the relevant course modules.

The limitation of Selective Response questions, however, is that students practice only a limited set of reactive skills.

Subjective and expressive exercises are needed to deepen students' understanding of the subject and hone their proactive skills. Essay questions make students practice their reasoning, articulation, organization, and professionalism in presentation. Problem solving questions and debates make students exercise their power of critical thinking, analysis, exploration of alternatives, establishment of criteria, and articulation of the choice. Case analysis and design questions practice students' skills of using methods of exploring requirement, analysis of inadequacies, design methodology, searching for available components of a design, and assessing feasibility and optimality of the creative elements. This segment of course practices are more important by far than the Selective Response segment; yet, in the present system, it is more subject to compromises, simply because of (a) the limited opportunities for student interaction with the faculty and (b) expecting that most of the exams are of Selected Response type.

In MCMEd, the emphasis is on the subjective and expressive exercises. The first line support for this type exercises is MCMEd's online PB, which provides many guidelines, templates, and samples for each item. Each item is doubly hyperlinked to the relevant course modules. Modules are also hyperlinked to other relevant module in the system, as well as referenced to copyrighted material outside the system. The second line of support is provided in the Affiliated School. The core activity of instructors and tutors at an Affiliated Schools is to help students to navigate through the CBK/PB and provide feedback on their subjective exercises, in person or through a live or remote helpdesk system.

In the next section, we explain how the PB prepares students for final exams. The PB in conjunction with the prospect of an upcoming course comprehensive final exam moves the student to the center of learning responsibility and mobilizes their learning motives and potential.

### III.3. Delivering the Content:

As discussed in the previous sections, MCMEd's system content (the sum of Course Knowledge Bases and their associated Practice Bases) are provided by the MCMEd Central trough the institution's intranet with proper access controls. Instructors at MCMEd Affiliated schools are responsible for helping the students to learn the provided content; they can add to the provided content if it helps the students, but they cannot ignore any part of the content because students will face a test that will cover the content comprehensively. The test and grades will be created and administered by the MCMEd Central independent of the instructor.

### III.4. Guiding and Coaching Students to Learn the Course Content:

Students who are enrolled in a course session offered by a MCMEd Affiliated School can access the content online. Instructors in these schools help the enrolled students to navigate the CKBs/PBs and help them with practices and additional explanations of the content when needed. In this arrangement, the student and the instructor know that the upcoming course final exam coming from the higher authority (the MCMEd Central) covers most, if not all, the main and supporting points throughout the course; therefore, in this system, it will be the student who will demand full coverage of the course from the instructor. This is in contrast to the present system as explained in section VI.1.

Sub-processes 5 “Creating and administering the quizzes and examinations” and 6 “Evaluating each student's performances in the course and assigning a grade,” listed under section III are quite intertwined. Therefore, in the following sections both sub-systems are addressed together. In the section III.5, the flaws of the present system are analyzed and in section III.6, the features and characteristics of MCMEd's testing and grading are presented. Based on the latter, MCMEd's system of Quality Control is presented in section IV.

### III.5. The Flaws of Testing and Grading in the Present System:

As in any organization, the prospect of HH-Ed depends on two interrelated fundamentals: accountability and responsibility. Accountability is the core of quality control in any organization. Measuring the quality of the output is the first and foremost requirement to see the effects of the quality of resources and the effectiveness of the involved processes. The best resources often wasted when quality control is casual and unattended. In education, quality of actual learning outcome is supposed to be measured by exams and grading. However, the lack of a consistent system of comprehensive testing and impartial grading in most HH-Ed has undermined the legitimacy of the present educational system: “ . . . The only surprise is that we should be surprised. What else did we expect? If the GPAs are as meaningless as the learning, maybe it's time to call a charade a charade,” writes Michael Skube, winner of a Pulitzer Prize for criticism, and professor of journalism at Elon University in North Carolina [6]. A wrong system of accountability is the source of deterioration:

### III.5.1. Chasing the Wrong Objective Variable:

Learning outcome is not the objective variable by which schools are budgeted; ‘enrollment’ is.

As an economic unit, the school must pursue higher enrollment, but higher enrollment must be the consequence of a higher learning outcome; such linkage does not exist in the present system, except in highly ranked institutions. Top universities have no enrollment problem. Their faculty members usually have strong standing; even in the face of low enrollment and course cancellation, faculty jobs are secured by research grants; thus the institution has no need to encourage or coerce teachers to increase enrollment. FIG. 8 is a subjective depiction of fast descending quality and rigor as we come down on institution ranking. As we come down on the ranking curve, the enrollment pressure builds up. The pressure has led to a wrong system of teacher accountability.

### III.5.2. The Wrong Teachers Accountability Measurement

It is correctly perceived that if we do not hold the faculty accountable, potential abuses will became actual. On that notion, first, peer-evaluations were established. However, peer evaluations were deemed suspect or insufficient the least, on the ground that peer can only casually observe each other's performance, and its reciprocity may pollute its fairness. Therefore, it was so perceived that a better evaluation will be by students who sit through the course and observe the teacher over the period of the course. The notions are deemed logical, and are defended under the assumption that students are adults who seek knowledge and skills, as they seek other life necessities. On this presumption, it became fashionable to treat students as customers, not realizing that emulating the market economy into educational institutions requires more than a fashion statement. While the presumption is partially correct, it ignores the many forces that deter students from studying [VI.2]. Per se, evaluation is good, but what corrupts the learning process is the reciprocity of the evaluation: students making judgment on the judge (the teacher) who is going to make judgment on their performance.

Students' dependency on the teacher's judgment is obvious—they need the grade and desire a higher GPA. Dependency of the faculty's job on their student's evaluation, however, is disguised; the culprit is the enrollment pressure on the teacher.

Enrollment pressures on teachers come from two sides, from the administration and from the students: From the administration side, enrollment concerns are explicitly conveyed to the faculty. In below-the-top institutions, the message is enforced by the administration's system of rewards and punishment incorporated in the Retention, Promotion, and Tenure process in which student evaluation is practically the major determining factor.

From the students' side, enrollment in a class suffers when they are not pleased with a teacher or his/her grading. When a course is canceled due to low enrollment, as often happens in the last minute, the faculty has to teach a course for which he/she is not prepared or has little interest to teach. The case is more threatening for part-time faculty, who constitute some 30-50% of the teaching force. For a part-timer, class cancellation means losing a piece of livelihood; and repeated course cancellation or unfavorable student evaluations results in losing the job. Repeated class cancellation puts even a tenured faculty in an uncomfortable and embarrassing position [5]. Aside from enrollment-coercion and punishment, popularity is a matter of joy, pride, and power; and often leads to awards, recognitions, and meritorious raise. Under these pressures, one way or the other, the faculty, part-timer or full timer, tenured or not, must please the customer in order to please the boss. Pleasing the customer sounds not only reasonable but the only way that an organization should function under the market economy; in education however, it is a naïve misperception that confuses and corrupts the educational process. In the market, the product is not created by the customer; and the customer is not being responsible, and therefore not being judged by the business. In education the student (beyond childhood age) must be at the center of learning responsibility. The student only buys support services in learning process. ‘Student as customer’ concept corrupts the learning process [VI.2.1. The fallacy of “Student as Customer”]. It shifts the learning responsibility to the teacher and the institution [VI.2.2]. In this atmosphere, many teachers, unintentionally and subconsciously, master the art of salesmanship—teaching something shallow and easy to digest, but ably convince the students that this is the whole thing in a well-structured nutshell, which is easy to grasp and they need not to be troubled with much work.

Although at the high school level, there is little or no student evaluation, the education suffers from another misconception that students are still ‘kids,’ thus, a lenient responsibility for learning is expected of them. Consequently, excessive indulgences are allowed to work against the learning process [VI.2.4].

Whether students are considered customers or kids, either misconception implicitly puts the teacher at the center of responsibility for learning, which creates a structural gridlock. It ignores the fact that learning is a function internal to the students; and the teacher has no control over the student's brain functions, and has very little, if any, control over the will of their students for learning. Only measured and rewarded objectives can create will; and only ‘will’ can mobilize innate resources; only then does the teacher have a chance to influence and mobilize student's will to learn.

Undoubtedly, even under the condition of conflict of interest, the personal dignity of teachers, as well as of the students, resist compromises. However, the wide spread grade inflation [6, 7, 8, 9 & 10], the burgeoning diploma-mill institutions, and the overwhelming number of complaints in the public media regarding the quality of education, all are testaments to the fact that the structural problems in the system often overrun dignity. When the pressures threaten the teacher's job, the course coverage, exams, and grading become subjects of compromise. This is not usually the case in the top institutions where there is little or no enrollment pressure. Moreover, in every school, we can find master teachers and self motivated students whose total and passionate focus on learning pushes aside any and every corrupting interferences coming their way. It is not enough that we acknowledge and celebrate, as we should, the minority of highly motivated students and master teachers; the market demands a system in which ordinary talents, among students and teachers, maximize the sum of all students' learning outcomes. MCMEd's primary design mission is to re-establish the golden principle: putting the student at the center of the learning responsibility and making the teacher and the institution responsible and accountable for the needed learning support system.

MCMEd treats students as customers without corrupting the learning process: Students are customers of MCMEd Schools: they evaluate the support that they get from their instructors and the school. Their performances, however, are evaluated independently by the faculty at the MCMEd Central. Therefore, MCMEd Central becomes the independent and invisible fair judge that judges student performance; but an entity out of reach of the student to influence or bargain for grades—further discussed in III.5.3. The judgment on the MCMEd Central is done by auditing, assessment, and accrediting bodies—further discussed in III.8.5.

### III.5.3. Unreliability of Exams and Grading in the Present System:

In other industries, it is inconceivable to have any quality control without having a serious output quality measurement. Education is the only industry in which a casual measurement of the output is norm. As depicted in FIG. 9, given two groups of students, comparable in background and ability, to two instructors to teach the same course, producing the same grade distribution for both groups, yet, one class may have covered several times more material and achieved more learning outcomes than the other class.

Presently, exams and grading are increasingly trivialized because serious exams and grading often have few, if any, advocates:
1) Testing and grading are difficult but unchecked, unsupervised, and unrewarded tasks. For the faculty, other than their personal and professional dignity, there is very little incentive to spend time and energy to make serious subjective (proactive: e.g., essay, design, case) exams, which then require spending considerable time to grade; and then increase the probability of dealing with the trouble of students' grade challenges or grievances, followed by unfavorable student evaluations and enrollment problems. Thus, the path of least resistance becomes popular: making short exams, limited to True/False and multiple-choice questions; score them by the machine, and grade them to the students' satisfaction. Consequently, many graduates cannot write complete sentences or present a coherent argument, because so few times they were expected to write or respond to subjective and involved questions.
2) For the student, other than his/her personal pride and dignity, there is no incentive to ask for serious exams. Even for serious students, when it comes to exams, understandably, their most frequent question is ‘What is on the exam?’ and their most frequent request is ‘fewer chapters on the test.’
3) For the administration, exams, and grading are not a priority. Exams and grading are considered totally in the realm of faculty responsibilities, unless there is the nuisance of students' grade grievances. In fairness, administrators are skillful managers in charge of securing resources, and their focus is expected to be on that task. What is missing is a system of learning accountability, which can maximize utilization of those valuable resources.
b 4) Advocates of the status quo may argue that the present tests are good enough samples of student knowledge. Selected Response tests, often having some 30-100 questions are advocated as statistically ‘good enough’. The argument of “good enough sample question” is analogous to the proposition that polling is good enough substitute for national voting; beyond the objective of picking the most qualified candidate, comprehensive voting engages the citizen in the democratic process. Similarly, even if the tests were done based on perfect statistical sampling method, which is not the case, they would not secure the mental commitment of the students to study in full. ‘Sampling tests’ give mental excuses to many students to limit their study to sampling of the course content rather than a sweeping study of the subject. The legitimacy of the education system depends on legitimacy of exams and grading as much as legitimacy of a democracy depends on the legitimacy of the ballot box.

### III.6. Testing and Grading In MCMEd:

Traditionally, teachers are given two roles: (a) guiding and supporting, and (b) judging the actual learning outcome. Mixing the two roles causes confusion in the learning environment: On the one hand, students need to trust and lean on their teacher's support. On the other hand, the apprehension, which comes with the judging authority of the teacher, distances them from the teacher. Furthermore, by separating the two roles in MCMEd, we break the reciprocity of evaluation and remove its corrupting consequences, which we explained in sections VI.2.2, VI.2.1, and VI.2.3. By decoupling the two roles, the students' focus changes from the teacher to the content that is the CKB/PB; their sense of responsibility moves to the content not toward the instructor.

In MCMEd, the judging role—exams and grading are done centrally and by the Exam and Grading Teams at the MCMEd Central, while teaching and tutoring are done at the MCMEd schools. In this arrangement, students see that the teacher is not the one who will judge them, but to support and prepare them for the course comprehensive exam.

Although testing-teams work at MCMEd Central independent of class instructors, they work in the framework of the CKB/PB. CKB/PB serves as the common ground between what has to be covered in the course and what the testing-team expects of the students. Therefore, the learning system remains consistent while teaching and testing are separated.

Exams and grading are at the core of MCMEd design. Grading is the most sensitive element in the formal education process. While many positive and negative factors influence students' motivations, as listed in section VI.2, grading is the most significant, clear, and present motivator. For students; nothing in the educational process is more disheartening, distrusting, and alienating than casual, unfair, or inaccurate grading. Preaching “students should learn for the sake of knowledge not for grades” is nice, but takes us nowhere in our struggles to educate our young.

To a large extend, the combination of three factors shape the studying behavior of the average student: (1) the expectation factor, (2) the support factor, and (3) the assurance of fair reward that is fair and impartial grading. MCMEd is designed to respond to these three factors: (1) Expectations are set by the promised comprehensive final coming from MCMEd Central. MCMEd Central acts as an invisible hand of a higher authority, which is beyond students' reach to influence the content of the test. (2) CKB/PB, instructors, tutors, and the helpdesk provide ample support. (3) Grading is also managed by MCMEd Central, independent of the instructors of the course. Consequently the possibility of abuses by the faculty to compromise on the course content, the exam, or the grading is practically removed. For the students, the apprehension from the instructor is replaced by a sense of trust and helpfulness; and indulgences [VI.2.4] are replaced by the sense of responsibility.

In MCMEd, exams and grading are at the core of accountability and quality control.

MCMEd exams are to be created by teams of highly qualified academics and professionals in the field. Many, but not all, questions/problems on the test come from the PB with minor modification. Members of testing-teams are also either participants in the CKB/PB production teams or intimately familiar with content of the CKB/PB. Close relationships among the members within and between these teams assure consistency between the format and content of the exams and the PB. Exams created by such teams are practically complete, practically error free, and consistent with what students have to experience with the CKB/PB. Such consistency cannot be achieved by external exams in the present system of HH-Ed [section VI.4].

Although creating MCMEd exams requires teams of highly paid faculty and professionals, in a large-scale MCMEd, they are significantly less expensive than the present HH-Ed exams, simply because they replace many otherwise low-quality mid-term and final exams created and conducted by numerous single-handed teachers.

MCMEd is not a system of ‘teaching to the test;’ it is, however, a system of teaching to a very large and comprehensive test bank, which is constantly updated; and always consistent with what has actually been covered in the course. The accepted principle in MCMEd is that if, and only if, students can respond adequately to the large number of questions, debates, problems, cases, analysis, and/or designs in the course PQB, the student will have learned the subject; and the comprehensive test will verify the extent of his/her learning.

In fact, MCMEd avoids the fundamental flaws of ‘teaching to the test’: First, MCMEd is not recommended for below high school level because we believe imposing the pressure of a firmly structured test at early age is not an effective or a safe approach to child development. ‘Teaching to the test’ puts pressure on the teachers to prepare the children for that intimidating selective choice test, to which the success of the student, the teacher, and the school are measured; this limits and actually distracts the teachers form paying attention to psychological and character development of the individual pupil.

Second, MCMEd's exams are largely subjective (expressive) type as opposed to Objective (Selective Response) type. In the present high school and higher education systems, tests are largely limited to a set of Selective Response questions; therefore students only learn how to react to questions. Selective Response tests are valuable in introductory courses, where learning a large number of new terminologies and a broad survey of a field is the goal. However, such tests have become, largely, the standard testing methods because of (a) the ease of machine grading and (b) saving the teacher from the nuisances of students' grade challenges. Ubiquity of Selective Response tests, however, is shortchanging the education not only at elementary level, but at the high school and higher education as well; they are limited and mechanical. “Are we building minds or machines? Teachers are asking.” [11]

The focus of education in MCMEd is on Proactive skills—skills that are needed for a wholesome professional life. In traditional education, for centuries we have had Subjective (expressive) exercises and tests. We elaborated on the significance and necessities of essay, problem solving, debates, case analysis, and design questions in section III.2.

MCMEd is not a system of ‘teaching to the test;’ it is, however, a system of teaching to a very large and comprehensive test bank, which is constantly updated. Criticisms cited against ‘teaching to the test’ are based on the inadequacies in such tests in the present HH-Ed, which are too little, too late [section VI.4].

The accepted principle in MCMEd is that if, and only if, students can respond adequately to the questions, problems, cases, design, etc., in the PB, the student knows the subject and thus deserves passing with the earned grade.

MCMEd is designed on the notion that there is no meaningful assessment method (quality control) without meaningful and comprehensive exams. That is why MCMEd's exams are comprehensive and predominantly of subjective (expressive) type. Such exams with impartial grading secure the trust of the students to study in full, and discourage them to look for ways to beat the system. Such exams with impartial grading define the legitimacy and prestige of the institutions built on MCMEd method.

### III.6.1. Features and Characteristics of Exams and Grading in MCMEd:

1) Preparing the student for MCMEd Final Exam: In MCMEd design, there is one formal comprehensive test per course. As a substitute for the traditional midterms, many stipulated, non-binding, practice-quizzes and practice-tests are included in the PQB to prepare students for the comprehensive final. The PQB includes tens of questions, problems, and cases for each module, which results in having a large question bank for a course, composed of thousands of items: problems, cases, debates, analysis, design, etc. PQB is essentially a continually updated and enlarged test bank, which is then used as the source of many, but not all, questions, problems, and cases on the final exam.

The practice-quizzes in the PQB are Selective Response items, offered and graded on-line. Subjective practice-tests in PQB are semi-automated: As the first line of support, the sample answers, templates, similar case analysis, and sample designs, are offered online, making self or peer grading an option. When further feedback is needed, there are instructors, tutors, graders, and the helpdesk to evaluate the student's work and provide feedback. Moreover, these tests are diagnostic tools for the instructors to find the student's weaknesses and offer remedies before sending the student to the comprehensive final. Instructors report the significant diagnostic episodes to the MCMEd Central along with their suggestions regarding necessary additions or changes to the CKB modules and/or PQB items. In this way, the system improves perpetually and evolutionary.

2) Practice-tests must have the same format as the comprehensive final. The consistency of format between PQB and the comprehensive finals assure students of no surprises, thus encourages students to go thoroughly through the course exercises in the PQB.
3) MCMEd has one formal comprehensive test per course. In substitute for the traditional midterms, many stipulated, non-binding, practice-quizzes and practice-tests are included in the PB to prepare students for the comprehensive final. The PB includes tens or hundreds of questions, problems, and cases for each module, which results in having thousands of questions, problems, and cases for a course. The PB is essentially a continually updated and enlarged test bank—the source of many, but not all, questions, problems, and cases on the final exam. The practice-quizzes in the PB are objective, allowing them to be offered and graded on-line.

Subjective practice-tests in PB are semi-automated. As the first line of support, the sample answers, templates, or similar case analysis and/or design are offered online, making self or peer grading an option. When further feedback is needed, there are instructors, tutors, graders, and the helpdesk to help the students. Moreover, these tests are diagnostic tools for the instructors to find the student's weaknesses and offer remedies before sending the student to the comprehensive final. Instructors report the significant diagnostic episodes to the MCMEd Central along with their suggestions regarding necessary additions or changes to the CKB modules and/or PB items. Thus, the system improves perpetually and evolutionary.

Practice-tests have the same format as the comprehensive final. The consistency of format between PB and the comprehensive finals assure students of no surprises, thus encourages students to go thoroughly through the course exercises in the PB.

4) In MCMEd, practice-exams replace the traditional mid-terms. Practice-exams as well as comprehensive final exams are proper blends of objective and subjective items. Computerized grading of objective questions is very inexpensive and rarely subject to students' challenges. The values and limitations of objective testing are discussed in IV.4. When used as the lone method of testing, the true education is compromised. Because of the ease of their grading, machine gradable exams (e.g. Scantron) are the predominant mode of testing in the present HH-Ed. When and where all expected of students is marking Scantron sheets or computer screens, many students graduate while unable to write complete sentences or present coherent arguments.
5) Grading subjective items is relatively difficult and costly. However, MCMEd has to pay this cost to assure achieving the following objectives:
a. Lead students' learning behavior towards deeper professional knowledge and skills (as discussed in IV.4 and II.5.)
b. Secure students' trust in a robust and fair education system,
c. Assure quality control of the actual learning outcome, and
d. Secure the legitimacy of the education institution.

In the present HH-Ed, grading is trusted to the professionalism of the grader; grading is usually unchecked and unsupervised. The monotony and repetition of reading students' answers to the same questions soon wears out the patience of the grader; and the consistency of judgment becomes harder to maintain. To overcome these deficiencies, in MCMEd, grading of subjective items goes through the following procedure: Students' responses to the subjective items on the test are dispersed to the network of graders. Each response to each question is sent to two graders. Each grader will receive the response on a web page in the MCMEd intranet with clear grading criteria and structure, which facilitate the speed and consistency of grading. The two assigned grades are then sent to the grading database. If the assigned grades are close as determined by the criteria set by the test-maker teams, the average points will be the judgment; if not, the response will be assigned to the third grader to establish consistency of grading. This automated policy will serve as an effective supervision mechanism to keep the grader aware that they must stay alert and consistent. Moreover, through data mining, the pattern of irregularity of a grader's work will be revealed and corrected.

The procedure is not as laborious as it seems, because the computer does all the clerical steps automatically; and the grade-guiding screen helps the grader to quickly focus on the content and make grading judgment.

Students' grading challenges can be dismissed as they are dismissed in national tests such as SAT, GRE, etc. With an alternative policy, however, the student either can request and pay for additional round of grading, or request and pay for arbitration by selected faculty, with the provision that if the first round of grading is found erroneous, the student will be refunded.

6) The testing and grading-teams are internal to MCMEd; they are intimately familiar and involved with the course CKB/PB. Therefore, complete consistency among the CKB, the PB, testing, and grading is preserved. Thus, students' experiences with prior practice-tests eliminate surprises and frustrations in the final exam.
7) On-line testing in secure testing facilities has the benefit of placing a time stamp on student responses. This makes the MCMEd grading system capable of measuring student performance in two dimensions:
a. Students' demonstrated knowledge and skills in the subject area for which they receive a grade, or percentile; and
b. Students' professional agility, for which they receive a Professional Agility Index (PAI). Professional agility is important in any field; however, the relative weight of the two scores may vary depending on the subject. The significance of the professional agility is more pronounced in applied fields and more valuable for certain hiring employers. For example, in a computer programming course, students receive two scores on their report card:
   i. a grade (percentile) for their demonstrated knowledge and skills of programming, and
   ii. a PAI to show how fast they can produce good codes.

### III.6.2. Other Benefits of MCMEd's Testing and Grading System:

The robustness of the MCMEd exam and grading system helps the students and society in several ways: First, it develops a different study habit—from glancing and sampling of the course content to full attention to main and supporting points in the subject. The benefit for society is the accumulation of greater intellectual assets.

Second, this robustness forms attitudes and behaviors toward responsibility and honesty, because it does not give students the opportunities to practice the vicious arts of manipulation, ‘beating the system’ and “sliding through the cracks”. These habits, if developed in their formative years, will have life-long negative consequences. The positive result for the society would be propagation of a stronger belief and commitment to meritocracy.

Third, since MCMEd's accountability system includes a versatile cost accounting subsystem, there is no reason not to allow the student to pay the cost and take a test repeatedly until reaching the desired proficiency in that course, or go back and take the prerequisites again. Limiting the number of times a student can take the course and the exam, in the present system, actually curtails the growth of many slow-bloomers. A serious problem with the present system is that it is one way street: students are pushed to the next classes while still having difficulties in some prerequisite pieces of knowledge and skills; and there is no provision to go back and remedy the prior inadequacies, [12]. The only option given is to dropout. In the Information/Knowledge Age giving up on true learning is not an option; as we do not give up on a child who has difficulty with walking.

Fourth, as a side benefit, comprehensive exams build “character of endurance.” If education is preparation for a productive life, sitting on long comprehensive tests is an excellent preparation for jobs and social functions, which require long periods of concentrated attention and high level of productivity.

### IV. TOTAL QUALITY MANAGEMENT (TQM) in MCMEd

A product sells in the market based on its Finished Good Quality (FGQ). However, the producer commits to TQM and measures the quality of each component and each stage of the production in order to assure the quality of the finished good while minimizing wastes in the production process.

TQM in MCMEd is achieved by measuring performances of every element in the system. Quality measurements of the input to the system and assets in the system: faculty, curriculum and programs, facilities, and administrative would be meaningless if the students' actual learning outcome is not measured accurately. Quality of each element is valuable proportionate to its contribution to the bottom-line: the actual learning outcome. That is why the core components of quality measurement in MCMEd are; 1) having comprehensive exams on undiluted course content and 2) creating an uncorrupted grading system.

### IV.1. Measuring the Actual Learning Outcome of the Student:

As depicted in FIG. 10, measuring learning productivity requires that we have an Input Metrics (e.g. the average of the student's prior scores in all or selected courses) and two measurements: a Preparedness Score and Course Score of the student. The ratio of the Course Score over Preparedness Score is Student's Course Productivity Index (SCPI) which objectively measures the actual learning outcome. SCPI of 1 would be an expected value; above 1 will show better than expected; and below that 1 would indicate less desirable productivity.

### IV.2. Measuring Productivity in Each Course:

Course Productivity Index (CPI) measures the actual learning outcome in a course session. CPI is the average of students' SCPI.

### IV.3. Faculty Development and Faculty Evaluation:

MCMEd is not a teacher less system; however, it is a design to relieve the instructor to concentrate on his/her main job that is to invigorate the individual student's enthusiasm and innate potential. Being faithful to the notion of ‘no student left behind,’ MCMEd relieves the instructors from mundane repetitive work so that they can attend more to their diagnostic role on individual students who need special attention.

Faculty development is shared between MCMEd Central and MCMEd Schools. The cohesion of MCMEd depends on faculty involvement in every step and stage of the learning process. FIG. 11 depicts the necessity of faculty rotation. In this figure the core shows the three basic products of the MCMEd Central: Course Knowledge Base, Course Practice Base, and Course Testing and Grading. These three must work consistently and congruently; therefore, the faculty members who are involved in these products must renew their research, their mastery over the courses, and their mastery over testing and grading. As well, they must be intimately in-touch with the learning process of students. To achieve such objective, faculty members are to rotate between these activities as well as among various academic teams:

Research: Course content, the curriculum, and the academic programs remain relevant and effective, but only if the faculty is engaged in research and professional activities in their respected field. The strength of the links between research, publication, and instruction defines the validity and legitimacy of the institution.

Centralizing research at MCMEd Central is beneficial for two reasons: First, better research facilities and support (laboratories, editorial services, statistical or technology support staff, etc.) can be accommodated in a large-scale institution than in smaller schools. Second, as the complexity of subject knowledge increases, interdisciplinary area becomes a fertile land for new research. Interdisciplinary research requires collaboration among professionals of various fields; a large-scale system can afford such colonies; a small school cannot.

Research facilities at MCMEd Central create the environment for Master's and Doctoral level programs, which further advances faculty's academic growth.

Course Mastery: Working on the mastery of the subject is an on-going part of the teaching job. Three sets of activities enforce faculty's mastery of their subjects: First, rotation of the faculty among academic activates (FIG. 11) gives faculty the opportunity to be, directly or indirectly, involved in the production of CKB/PB items and exams, as well as in the organization of course structure, curriculum, and programs. Second, the faculty-at-large are part of the anonymous grading network (with the provision that the instructor does not grade his/her own students for the reasons stated in section III.6.) Third, CKB/PB items and exams are beta tested on faculty before distribution to schools and testing facilities.

Teaching/Tutoring: Classroom activities, in physical and/or virtual settings, constitute the core activity of instructors and tutors at MCMEd Schools. These activities include helping students to navigate the CKB/PQB, discussing the difficult issues, giving feedback on assignments and practice-tests; and most importantly, keeping the students on course, and leading them to successful comprehensive finals.

Out of the classroom, faculty members are to be involved directly, or in a supervisory role, in tutoring. This can be done in person, through the MCMEd intranet, individually, in small groups, and/or through the helpdesk system.

Navigating through the expanding CKB/PQB often requires a mastery of information literacy. This is a fundamental skill that instructors must nurture in their students. “ . . . Information literacy knowledge and skills are most effectively learned when developed recursively within the context of discipline-related need . . . ” writes Judith Peacock, a widely published expert in Information Literacy at Australia's Queensland University of Technology, [13].

Another important task for the faculty is forming and supporting small study groups. There is a considerable untapped learning potential through group study. Teamwork stimulates members' learning potential, and creates the attitude of cooperation, which throughout one's life produces higher work productivity and social harmony. Presently, in many classes, individual competition often becomes a disincentive for students to help each other. Students in each class compete with each other for better grades because grades are often curved locally in that class. In MCMEd, grade distribution can be system wide, therefore, competition between MCMEd Schools becomes an additional incentive for faculty and students at every MCMEd class to practice and prepare as groups and teams.

### IV.3.1. Faculty Evaluation

A faculty's instructional performances in a particular course and periodic overall are objectively measured by respective average CPIs.

Other performances of the faculty include:
1. Research,
2. Contributions to the CKB/PB,
3. Contributions to the Tutorial/Helpdesk system,
4. Diagnostic contribution to the system (as discussed in III.6.1, and IV.3),
5. Feedback on all academic activities, in particular on course structure, curriculum, and programs.

These performances are largely subject to peer and administrative evaluations.

### IV.4. Measuring MCMEd School Productivity (SP)

SP is the average of CPI for all course sessions offered during a period. SP objectively measures a school's performance in mobilizing the students and faculty toward higher learning outcome. SP is the school's measurement of Finished Good Quality, relevant to outsiders and insiders. SP tells the outsiders (student, parents, the sponsor, and the community) what learning outcome they should expect for that school; and the school can look at all SPs and see how it fares relative to other schools in the MCMEd system. Since SP is an objective measurement of the learning outcome at a particular school, there will not be a need for separate external assessment and accreditation of each school.

### IV.5. Audit Control at MCMEd Central

What is produced at the MCMEd Central are CKB/PQB, exams, grades, curriculum and programs. The quality of these products and services, and how they are carried on, must be audited on a regular basis by an independent assessment/accreditation body.

In the present shop-mode education, the processes involved in ranking, assessment, and accreditation require thousands of hours of faculty and administrators' time to spend on interviews and documentation for every school that applies for accreditation. After all that, still the accrediting bodies cannot measure what course coverage actually occurs in various classes and how much real learning is produced. The reason is that there is no consistency between course coverage, the learning processes, the exams, and the grading in different classes, see III.5.1.3. Therefore, these bodies are unable to measure the learning outcome of the school. Instead, they try to measure the input to the system or physical and academic asset in the system; they evaluate:

Academic reputation,

Facilities, financial, and academic resources,

Student selectivity,

Faculty qualifications and their academic activities,

Sample syllabi, exams, and grades.

These are largely inputs to the system or assets in the system not the output. This is a mock and transposed quality measurement, which will be ridiculed if suggested for any other industry. In other industries, quality controls of input and processes are performed in relation to the quality control of the output—the finished product.

Auditing MCMEd can be performed fast and paperless: In MCMEd, the content and processes of the learning system, as well as the records of learning outcomes are controlled by one integrated system of CKB/PQB, exams, and grading; therefore, the system remains consistent and verifiable. There is no need for extra documentation, all the documents are already online; the accreditation team can access any part of the system and report their judgment.

### V. DATA INFRASTRUCTURE OF MCMED

FIG. 12 is a simplified version of Entity-Relationship Diagram which represents a minimum data infrastructure need for MCMEd. In addition to reflecting the data-model of MCMEd, the diagram also shows the integration of the education sub-systems in MCMEd.

In this diagram, diamond shape symbols, with a number inside, refer to the relationships of the two data entities (sets of data) connected with arrows. The relationship marked (*) at the end are unique to MCMEd; others may be found in the present system as well. The meaning of each data relationship is as the following.
Relationship 1 means one program can have 0, 1, or many courses in the institution's catalog.
Relationship 2 means one faculty or one professional has qualifications and contributions to 0, 1, or many courses development; and every course is developed by many faculties.
Relationship 3 means every course in the catalog is composed of many modules; and each module is incorporated in 1 or many courses. (*)
Relationship 4 means every module has many practice items. (*)
Relationship 5 means one course in the catalog is offered 0, 1, or many sessions throughout its life cycle.
Relationship 6 means one faculty has contributions to 0, 1, or many modules; and one module is developed by 1 or many faculties. (*)
Relationship 7 means one faculty has contribution to 0, 1, or many courses-sessions; and one course-session has contribution from 1 or many faculties. (*)
Relationship 8 means one course-session is composed of one or many modules; and one module is incorporated in many course sessions. (*)
Relationship 9 means one student has 0, 1, or many enrollment records. (*)
Relationship 10 means one course-session has 0, 1, or many enrollment records. (*)
Relationship 11 means one course-session has 1 or many scheduled exams. (*)
Relationship 12 means one scheduled exam has 1 or many exam-items.
Relationship 13 means one exam-item is drawn from 0, 1, or many practice items. (*)
Relationship 14 means one enrollment record has 0, 1, or many records of exam registration, which may includes a grade. (*)
Relationship 15 means one scheduled exam has link to 0, 1, or many exam-registration-grade record.
Relationship 16 means one exam-item (sent to 1 or many graders) has 1 or many item-responses (from the graders) with assigned grade. (*)
Relationship 17 means one grader has 0, 1, or many item-response-grade records. (*)
Relationship 18 means one item-grade is calculated based on 1 or many item-response-grade records. (*)
Relationship 19 means the grade in one exam-registration-grade record is drawn from 1 or many item-grade records.
Relationship 20 means the average grade in a course-session is calculated from 1 or many exam-registration-grade record.
Relationship 21 means one record of faculty-performance may have the average grade for a course-session as part of his/her performance.
Relationship 22 means one faculty has many faculty-performance records.

### VI. FURTHER PRIOR ART COMPARISON

### VI.1. Compromises in the Course Content

In the present HH-Ed, course content suffers from several compromises:
1) Offered contents are not consistent, they vary from teacher to teacher, from term to term, and from school to school. The lack of consistency of course coverage is discussed in section III.5.1.3.
2) Course content is limited by the knowledge and interest of the teacher.
3) Under competition for enrollment, schools are becoming alert as to what new program or courses the market demands. The alertness is good; the trouble is finding the expertise and facilities to manage these courses. This is especially troublesome for small schools. Where and when there is no assigned time for new class preparation, the faculty has to master the subject as he/she is teaching the course. Often, the existing faculty scrambles between many subjects.
4) When a session is cancelled, coverage of course material is often shortchanged.
5) In section VI.2, we show further how the system is being corrupted.

Course content in MCMEd is not subject of any of the above compromises; it is defined by CKB/PB, and the comprehensive test demands full course coverage.

### VI.2. Conflict of Objectives in the Higher Education and its Consequences

To the education enterprise, the market is misread, misused, or abused: the society assumes it is paying for ‘learning outcome,’ but the market rewards the institution for enrollment. If actual learning outcome would have been concretely measurable and proportionally rewarded, then true learning would have been produced. Instead, enrollment as the concrete measurable objective is rewarded proportionally. The race, therefore, is for higher enrollment; learning outcome is secondary and measured casually and ineffectively.

Enrollment is the source of livelihood for the teachers and for the administrators. The dignity of these professionals resists compromises, however, in time, the harsh reality of livelihood erodes the resistances; learning deteriorates, while grades are increasingly inflated [6, 7, 8, 9 & 10].

Top universities have no enrollment problem, thus the institution has no need to encourage or coerce teachers' compromises. Teachers usually have strong standings; even in the face of low enrollment and course cancellation, faculty jobs are secured by research grants. As we come down on the ranking curve, the enrollment pressure builds up; and students' satisfaction becomes the primary objective. “Students are customers” is a false premise [section VI.2.1]. It is, however, institutionalized based on the optimistic assumption that students are adults who will do their part in the learning process because of:

a) Love of learning, curiosity, and sense of nobility,

b) Promise of better economic future,

c) Outlook of association with more intellectual people, including marriage,

d) Family and cultural pressure on students to do well at school,

e) Group-loyalties among students: helping friends to do well,

f) Peer competition,

While the above assumptions are true in many cases, it ignores the following distracting realities in the students' life that sabotages the positive motivations and noble intentions:
A. Immediate priorities: working for living, obligations towards family, friends, and social associations,
B. The lure of entertainment and social pleasures,
C. Getting bored by the subject,
D. Physical and mental fatigue,
E. Attention deficit and other physiological and psychological inadequacies,
F. Urge to quit due to the fear of competition,

Students' response to these positive and negative forces varies. However, for the majority of the students, future promises are uncertainties into the future; the immediate objective is to pass the course. If ready, the teacher is happy to serve the customer with a good grade. The trouble is how to pass if one is not ready? The customer expects special considerations. The response to the expectation varies depending on faculty's standing and on the level of enrollment-pressure on the teacher and on the institution.

Students' evaluation of the teacher has become increasingly important to the point that teacher's job security largely hinges on these evaluations. There is an obvious inherent conflict of interests: the teacher has to make judgments on the performances of the students, who are going to make judgments on their own judge. The conflict of interest, however, is brushed aside on the assumption that students' and teachers' dignity will prevent corruption of the process. Most people in every group and society are decent and dignified. However, in the Western world, elimination of conflict of interest is a legal and ethical principle. The wisdom of the West has found that conflict of interest clouds judgment, pollutes perceptions, erodes fairness, and in time corrupts the processes. In higher education, however, reciprocal evaluation is sanctified in spite of its obvious built-in conflict of interests [VI.2.2.]

### VI.2.1. The Fallacy of “Student as Customer:”

Under ‘enrollment-based’ budgetary system, students are customers, and customer satisfactions must be assured otherwise enrollment will suffer. Customer surveys are essential to guide the business. Thus student opinion surveys (read: students evaluation of the teacher) have become the core performance measurement of the faculty. The mandate to the teacher is clear: “Adjust the service to customers' satisfaction.” While many students are self-motivated, others yield to other priorities [section VI.2] but still expect undeserved grades and diplomas.

“Customers are right and customers must be satisfied” is a false argument hidden behind a seemingly legitimate statement. Who can argue with the validity of seeking ‘customer satisfaction?’ After all, it is the very principle guideline of any enterprise in a free economy. However, there are two flaws in the argument: First, in the market, the product is not created by the customer; and the customer is not being responsible, and therefore not being judged by the business vs. in education, the student is the prime responsible party for creating the product—the learning outcome.

Second, the confusion is about “who really pays for education?” On the surface, three parties directly pay for education: public (governments and donors), parents, and students; however, in reality parents and students invest in education, and reap the returns on investment. In the long run, employers (public and private) pay for the fruits of investment proportionate to the quality of generated education. No matter who writes the check, one way or the other, it is the society, which foots the education bill.

Undoubtedly, the real customer—the society, is willing to pay only for true learning outcome. However, the society is largely passive and silent. The grade-hyperinflation [6, 7, 8, 9 & 10] attest to the fact that the schools are tuned to the objectives of the present and vocal client—the students. The result: “Education: Doing Bad and Feeling Good,” [14]

### VI.2.2. The IIIs of Reciprocal Evaluations in Higher Education:

Disclaimer: There are master teachers who manage to motivate the students and demand high standards without the threat of course cancellation or poor students' evaluation. Their percentage, however, are far few and in between. The ordinary majority, however, are at the mercy of the students because of Enrollment-motives and Reciprocal evaluation.

On the books, student evaluations of the teacher are one of several measures of performance for the teacher; operationally, however, at every stage of Retention, Tenure, Promotion, and Post-Tenure evaluations, the faculty members are reminded that their student evaluations are the core-measurement of their teaching performances. Where and when accreditation concern is paramount, a few faculty can survive mediocre student evaluations, only if they have publication numbers to support accreditation. At the lower ranked institutions, faculty jobs are entirely at the mercy of their students' evaluations. Moreover, the pride of student evaluation is institutionalized to the point that tenured or not, every faculty has reason to be concerned about the rating they get from their students. Aside from enrollment-coercion and punishment, popularity is a matter of joy, pride, and power; and may lead to awards, recognitions, and meritorious raise. Unpopularity may lead to course cancellation and its aftermath. When a course is canceled, which often happens in the last minute, the faculty may have to teach a course for which he/she is not prepared or has little interest to teach. In case of part-time faculty, a piece of livelihood is lost when a course is canceled. Repeated cancellations of the faculty's classes put even a tenure faculty in an uncomfortable and embarrassing position [5].

As in any case of conflict of interests, the dignity of both teacher and students resist compromises; but the reality of survival erodes the resistance with increasing force as the end of the term approaches. The teacher and the students know this inevitable reciprocal dynamic from the beginning. In time, compromises erode the depth and breadth of the course content [section VI.1]. A bigger danger, however, is that students, in their formative years, may internalize the art of ‘beating the system when so is desired.’ Such unintended training is contrary to the whole notion of education—damaging the individual as well as the society.

### VI.2.3. Teachers at the Center of Learning Responsibility:

It is well understood that teachers and the institution cannot create knowledge and skills in the mind of the student; they can only create the environment for the student to exercise learning. Among educators, it is a matter of a consensus that the student must be at the center of learning responsibility, and the teacher and the administration at the supporting roles. In reality, however, two misperceptions have gone against this principle and, as the result, have sabotaged the learning process:
1) High school students are perceived as ‘kids,’ thus, a lenient responsibility for learning is expected of them.
2) Higher education students are considered ‘customers;’ as discussed in sections VI.2 and VI.2.1.

These two misperceptions have put the teacher at the center of responsibility for learning and have created environments of indulgence [VI.2.4] in which the attitude of “you make me learn and pass me with a good grade’ and ‘you make me learn, but allow me do whatever I like,’ are allowed. The structure and processes of MCMEd do not allow such indulgences.

MCMEd's primary design mission is to re-establish that principle: putting the student at the center of learning responsibility and making the teacher and the institution responsible and accountable for the needed learning support system.

### VI.2.4. A Culture of Indulgence in the Midst of a Culture of Responsibility:

Observing high school students' behavior and performance [2], one has to conclude that, beyond exercise of freedom, the system allows indulgence. Behavior of some college students is not far behind [3, 16]. While most students have significant sense of responsibility, the indulgence of the few quickly breaks down the culture of responsibility in that school; indulgence has the capacity to spread fast. The paradox is that these schools are in America where working culture is highly disciplined, responsible, and its bottom-line, objective accountabilities, leave no room for indulgence. Almost all of the same students, including a large number of dropouts, go to work and quickly become responsible members of a responsible production team. This quick transformation happens because in the work environment limits and responsibilities, gains and loses, are clearly delineated. The worker soon learns that his/her performance, in large part, depends on his/her cooperation with the rest of the crew. Worker's performance is observed and measured by his/her superiors and co-workers; and the invisible mighty hand of the market economy reward the worker with $x per hour work. The worker quickly learns that the invisible authority of the market is formidable force.

The costs of indulgence are two folds: one cost is the reduced learning quality for all students and consequently less intellectual assets for the society as whole. The other cost caused by the few who, remain in the rebellious mindset of high school days, continue to challenge the authority at work and in the society; and the society pays for their unhappy fate in unemployment/welfare system and in legal and correctional systems. How many lives and how many dollars we will save if we change that mindset in those formative years?

Business knows that indulgence of even a few can break up the organization's culture of responsibility. The conscious of business sees the invisible hand of the market that can reward the business with growth and success or punish it with loses and bankruptcy. Therefore, business is very committed to preserving that culture of responsibility, and leaves no room for indulgence. This is not the case in most school environments.

In the mind of most students, limits, responsibilities, gains, and loses, are ambiguous. In that ambiguity, the authority given to the teacher is misinterpreted as total responsibility for learning outcomes. That presumption creates damaging subliminal assumptions for many students: ‘you make me learn; while I am not sure why I should learn the stuff you are trying to teach me!’ and ‘you make me learn, but allow me to do whatever I like.’

Challenging authority is the hallmark of adolescence. In the environment where there are enough unruly students, the challenge wears out the faculty and the system. In the present system, the authority given to the faculty and administrators: to discipline students, pass them or fail them, give them good or bad grades, has proved to be inadequate measures against the challenge.

In the present system, rewards are insufficient to motivate students to reach for their maximum potential. For many students, the presence of the invisible hand of the market and promises of future opportunities, are neither clear nor present; there is only a vague promise of the rewards and punishment in the far future: when they grow up, after they graduate.

MCMEd takes this lesson from the invisible power of the market and the discipline of the work environment it creates. Through a system of comprehensive exams, produced and graded independently of the teacher, but supported by teachers and a robust system of CKB/PB(s), MCMEd creates a similarly strong invisible hand that cannot be challenged.

### VI.2.5. The Hidden Costs of Empty Diplomas are Enormous:

“A survey of teenagers conducted by the National Constitutional Center found more students able to name the Three Stooges (59%) than could name the three branches of the U.S. government (41%). Another survey of students at 55 elite colleges and universities done in 1999 found that 40% of them couldn't place the U.S. Civil War in the correct half-century,” writes Jonah Goldberg [17].

The worker of the first half of the 1900s could survive with little professional knowledge and information. There was little pressure for higher education. For the average citizen, holding diplomas was helpful but not a prerequisite for a decent economic life. Therefore, the students, faculty, and the institution could stay true and honest to the traditional ‘social contract’ in the education system. The context changed drastically in the second half of the 20^{th} century. The knowledge and information content of most, if not all, jobs have been increasing. Having proof of higher education—showing a diploma, has become a minimum prerequisite for a large percentage of jobs.

Education remains a highly labor intensive, and to produce labor for education, more education of higher level is needed. In the chaos of the unregulated education market, the response is easier diplomas for sale at escalating costs.

Beyond its moral implications, empty diplomas present tangible damages that in time destroy the fabric of the society, among them:
1) It is one thing to have illiterate masses; it is a different thing to have barely literate masses with high school, baccalaureate, Masters', or Doctoral degrees in hand. Hardly-literate diploma-holders have the illusion of knowledge. The empty degree produces the subliminal assumption that ‘I have the degree, and anything I don't know must not be important, otherwise I would have learned it in the program.’ The damage of ignorance is far greater when it is blended with illusion and arrogance. Now, imagine such masses in the western world inheriting so much wealth and military power. Further, imagine the underdeveloped and developing world, in the absence of a ubiquitous meaningful education, plagued with ignorance, disease, poverty, overpopulation, and violence. The combination will leave little chance for the mother earth and its habitants to thrive, if to survive at all.

With legitimate education, both the employee and the employer would know where they stand. They both know what inventory of skill/knowledge they have and what further knowledge and skills are required for tasks ahead.

In the present system, where legitimate grades and diplomas are hardly distinguished from semi-legitimate or empty ones, that clarity is regrettably absent. Employers take their chances with the candidate who has a better articulation and charisma; then after a long period of trial and error, in a game of hide and seek; finally, they learn what they have got for their money. The duration of trial and error is much longer for public sector employers [14].

“Over the next 25 years or so, as better-educated individuals leave the workforce they will be replaced by those who, on average, have lower levels of education and skill. Over this same period, nearly half of the projected job growth will be concentrated in occupations associated with higher education and skill levels. This means that tens of millions more of our students and adults will be less able to qualify for higher paying jobs. Instead, they will be competing not only with each other and millions of newly arrived immigrants but also with equally (or better) skilled workers in lower-wage economies around the world.” Quotation from “America's Perfect Storm, Three Forces Changing Our Nation's Future,” a Policy Information Report published by Educational Testing Service, Policy Evaluation and Research Center in January 2007. [18]

Empty degrees, in many circumstances, qualify many unqualified candidates for jobs requiring ‘minimum qualifications,’ employers, who, under pressure hire such individuals, shoulder the wasteful cost of these empty diplomas. Terminating an employee in public sector is a much longer, elaborate, and costly process. Again, public sector takes a larger share of the waste.

Aware of this process, the future employees in the pipeline, the students, see less incentive for true learning, and more incentive for learning the arts of presentation and manipulation. The greatest damage of the present corrupted process is that we train our young to focus their mental energy on finding ways to manipulate the system.
1. Higher education is the feeder to the other two ends of education continuum. On one end, higher education provides K-12 teachers; its poor quality breeds poor quality of K-12; and poorly educated high school graduates who enter higher education unprepared; the vicious cycle fast empties the knowledge assets and competence of the nation.

On the other end, higher education produces research force; its lower quality makes research more costly and, in time, forces the research establishments to import or outsource needed skills; both of which erodes the American scientific hegemony and academic superiority [19].
2. The damage to social fabric is imminent: The noblest notions of freedom of choices and true democracy are based on the premise that the majority of voters are informed and capable of analyzing issues. Knowledgeable people in the society often assume positions of leadership; the rest, often listen to their analysis and opinions. Having the illusion of knowledge, holders of empty diplomas hardly listen to anybody; they assume others must listen to them.

Our justice system depends on whether the twelve good persons on the jury are capable of analyzing facts within the framework of laws of twenty first century. When illusion of knowledge replaces the real one, justice, democracy, and the social fabric is under threat.

“Liberty cannot be preserved without general knowledge among people,” John Adams, 1765.

General knowledge needed in 21^{st} century to preserve liberty must be commensurable to the complex technology and intricate social institutions of our time.

MCMEd hermetically seals the education system against trivial exams, undeserved grades, and empty diplomas. CKBs, PBs, comprehensive exams, and impartial grading system prevent teachers to compromise on the content or the tests, and prevent students' undue influence on the teacher to receive undeserved grades and diplomas.

### VI.4. Insufficiency of External Exams in the Present HH-Ed

Because in the present HH-Ed, exams, and grades, as measures of learning outcome, are discredited, the policy makers and accreditation bodies pressure the schools for external exams.

We see exams such as SAT, High School Exit, or undergraduate exit exams as too little too late. Too little, because one largely multiple-choice exam cannot test the knowledge and skills gained in years. Moreover, there is inherent inconsistency between what the students have studied and the format and content of the tests because the teacher and the examiner are disconnected entities. Too late, because by the time the students are about to exit the program the accumulated inadequacies of their past years in the program cannot be remedied.

In an article titled “California's exit exam fails employers”, Russell Rumberger, a professor of education and director of the UC Linguistic Minority Research Institute at UC Santa Barbara says: “ . . . the state exit exam ignores “non-cognitive” social skills—motivation, tenacity, trustworthiness, perseverance, etc. These are difficult to measure but highly valued by employers. Research studies show that 70% to 80% of a high school diploma's market value—measured by earnings differences between graduates and dropouts—can be attributed to these skills, [15].

### REFERENCES

[1] Bok, Derek. Our Underachieving Colleges: A Candid Look at How Much Students Learn and Why They Should Be Learning More. (2007). ISBN 0-691-13618-1. Review From: http://press.princeton.edu/titles/8125.html
   (Derek Bok is President Emeritus and Research Professor at Harvard University and the author of many major books on higher education.)
[2] Landsberg, Mitchell “The Vanishing Class: Why Does High School Fail So Many?” Los Angeles Times, a 5 pieces series Jan. 29, 2006.
[3] Inside HigherEd, “Hey, You! Pay Attention!”http://insidehighered.com/news/2008/04/18/laptops, Apr. 18, 2008.
[4] Fink, L. Dee “Active Learning”, University of Oklahoma Instructional Development Program, Jul. 19, 1999.
[5] Bolander, Kimberly “Prof's empty classes under investigation”, The Orion News, http://orion.csuchico.edu/Pages/vol40issue7/n.investigate.2.html), Mar. 11, 1998.
[6] Skube, Michael “Straight-A ignorance: Students' GPAs are skyrocketing, but their knowledge is plummeting”, Los Angeles Times, Mar. 4, 2007. From http://www.latimes.com/news/opinion/commentarv/la-op-skube
   (Michael Skube is a professor of journalism at Elon University in North Carolina and winner of a Pulitzer Prize for criticism.)
[7] Mansfield, Harvey C. “Grade Inflation: It's Time to Face the Facts”, The Chronicle of Higher Education, Apr. 6, 2001. From: http://chronicle.com, Section: The Chronicle Review, Page: B24
   (Harvey C. Mansfield is a Professor of Government at Harvard University.)
[8] The Economist, “Grade expectations,” Mar. 18, 2004. From: http://www.economist.com/printedition/displaystory.cfm?story_id=2521490
[9] Landsberg, Mitchell “Grades are rising but learning is lagging, federal reports find,” Los Angles Times, Feb. 23, 2007
[10] Arnold, Roger A. “Way That Grades Are Set Is a Mark Against Professors: A warding students A's for C-plus work robs the best and brightest.” Los Angles Times, Apr. 22, 2004.
   (Roger A. Arnold is professor of economics at Cal State San Marcos.)
[11] Gust, John “Are Schools Building Minds or Machines?” Los Angles Times, Nov. 6, 2004.
[12] Klein, Karin “What does it take to learn algebra? First you have to master the fundamentals”, Los Angeles Times, Feb. 4, 2006
[13] Peacock, Judith “Chapter 3, Beyond the Fashionable: Strategic Planning for Critical Information Literacy Education” in Susan Carol Curzon & Lynn D. Lampert (Ed,) Proven Strategies for Building an Information Literacy Program, ISBN-13: 978-1-55570-608-1, Neal-Schuman Publisher, 2007.
[14] Krauthammer, Charles “Education: Doing Bad and Feeling Good”, Time Magazine, Feb. 9, 1990.
[15] Rumberger, Russell W. “California's exit exam fails employers”, Los Angeles times, Opinion, Jan. 29, 2006.
[16] Abrams, Susan “Missing manners a rude awakening in college classes”, LA Daily News, Oct. 21, 2006.
[17] Goldberg, Jonah “Western civilization, and other fairy tales”, Los Angeles Times, Feb. 5, 2008, http://www.latimes.com/news/opinion/commentary/la-oe-goldberg5feb05,0,3338070.column
[18] Educational Testing Service, Policy Evaluation and Research Center, Policy Information Report: “America's Perfect Storm, Three Forces Changing Our Nation's Future,” January 2007.
[19] Baltimore, David “When Science Flees the U.S.” Los Angeles Times, Nov. 29, 2004.
   (David Baltimore won the Nobel Prize in Physiology or Medicine, for his research in virology, in 1975. He has been president of Caltech since 1997.)

### A BRIEF DESCRIPTION OF THE FIGURES (DRAWINGS)

This is an institutional level Business Method Patent application; the figures are only qualitative (not quantitative, with no measurement) visualization of the described specification.

FIG. 1, the Actual Learning Outcome, the sum of Learning Potential, and Cost per Student per Course are plotted on subjective scales of Institution Rank and the Average Quality and Rigor of learning in various institutions. The message of this figure is to visualize two enormous wastes in the system: one is the wasted resources: the difference between the collective Actual Learning Outcome that we get vs. the cost we pay for education. The other waste is the difference between the actual vs. potential learning capabilities in our students. At the top, some 5% or so, we have very high quality institutions that produce high quality learning outcomes, though at very high costs. This small percentage of top institutions represents American education, especially to the international community. They camouflage what is beneath. Below-that-top, the quality and rigor dive down drastically, but, the cost does not come down proportionally; meaning that throwing money at a structurally flawed system cannot solve this collective problem. This below-the-top majority of institution is the focus of MCMEd. In this document, we referred to this majority as ‘the present system,’ or ‘the present education.’

FIG. 2, in any production system, three variables are of prime importance: cost, quality, and consistency of the product. Consistency is the reverse of variability; for example, products B and C, may even have the same average cost and average quality, but B has a higher variability. In such cases, the deceptive marketing plays a bigger role in the success of the business than substance of the product—at the expense of the customers. The transformation of production from shops to the assembly lines reduced the cost, but more significantly, reduced the variability in the product quality. In time, what comes out of these assembly lines (M,N,P, . . . X, Y products) are increasingly more consistent; therefore, the consumer has an easier decision making on the two dimensional Cost-Quality product space; and the producer has to compete within the two dimensional Cost-Quality product space.

FIG. 3, In the present education system, the teacher develops, delivers, manages a course, and then judges the learning outcomes of individual students by assigning grades. The teacher is, most often, the researcher, content provider, deliverer, exam maker, exam proctor, and the grader.

FIG. 4, The core in this figure represents the MCMEd Central, in which (a) teams of faculty do research and produce content in several format; (b) MCMEd's intranet delivers the content; (c) teams of faculty make the exams and their assistants proctor exams; and (d) MCMEd's intranet sparse the responses and deliver them to the grading network and collects the scores and calculate the overall grade. Affiliated Schools are depicted as orbiting the MCMEd Central; they receive the content, deliver them to students, coach, train, and motivate the students, keep them on course, monitor their progress, and prepare them to take the course comprehensive exam.

FIG. 5, represents the following processes:
7. Extracting the Course Knowledge Base (CKB) from the broader well-structured System's Knowledge Base of interest to the institution.
8. Creating the related set of review questions, problems analysis of cases, and/or design and development practices to foster active learning of the course content, the CKB. We refer to this set as “Practice Base, PB.
9. Delivering the content.
10. Guiding and coaching students' practices to learn the course content.
11. Creating and administering the quizzes and examinations; and
12. Evaluating each student's performances in the course and assigning a grade.

FIG. 6, Three layers of knowledge are identified: The highest level knowledge is the most ambiguous layer, which is the subject of original research. The next layer is somewhat known, often experimental, knowledge and skills.’ The third layer is the well-structured knowledge and skills. The main struggle of human race is against the unknown. At the forefront of this struggle, first line researchers gradually bring pieces of the unknown into the somewhat-known. Doctoral research programs are designed to bring fresh troops into this frontier. Masters' Degree programs are setup to bring pieces of somewhat known into known and often applicable territory. Finally, teachers and textbook authors make the known into well-structured knowledge to nurture high school and undergraduates learners.

FIG. 7, depicts the relationship of modules, subjects, courses, and programs in an education system. The relationship of Module and Subject is many to many; that is a subject is composed of one or more modules; and a module may be incorporated in more than one subject. The same (many to many) relationship exists between subjects and course, and between courses and programs.

FIG. 8, is a subjective depiction of fast descending quality and rigor as we come down on institution ranking. As we come down on the ranking curve, the enrollment pressure builds up.

FIG. 9, given two groups of students, comparable in background and ability, to two instructors to teach the same course, producing the same grade distribution for both groups, yet, one class may have covered several times more material and achieved more learning outcomes than the other class.

FIG. 10, measuring learning productivity requires that we have an Input Metrics (e.g. the average of the student's prior scores in all or selected courses) and two measurements: a Preparedness Score and Course Score of the student. The ratio of the Course Score over Preparedness Score is Student's Course Productivity Index (SCPI) which objectively measures the actual learning outcome. SCPI of 1 would be an expected value; above 1 will show better than expected; and below that 1 would indicate less desirable productivity.

FIG. 11, depicts the necessity of faculty rotation. In this figure the core shows the three basic products of the MCMEd Central: Course Knowledge Base, Course Practice Base, and Course Testing and Grading. These three must work consistently and congruently; therefore, the faculty members who are involved in these products must renew their research, their mastery over the courses, and their mastery over testing and grading. As well, they must be intimately in-touch with the learning process of students. To achieve such objective faculty members are to rotate between these activities as well as among various academic teams:

FIG. 12, is a simplified version of Entity-Relationship Diagram which represents a minimum data infrastructure need for MCMEd. In addition to reflecting the data-model of MCMEd, the diagram also shows the integration of the education sub-systems in MCMEd. In this diagram, diamond shape symbols, with a number inside, refer to the relationships of the two data entities (sets of data) connected with arrows. The relationship marked (*) at the end are unique to MCMEd; others may be found in the present system as well. The meaning of each data relationship is as the following.
Relationship 1 means one program can have 0, 1, or many courses in the institution's catalog.
Relationship 2 means one faculty or one professional has qualifications and contributions to 0, 1, or many courses development; and every course is developed by many faculties.
Relationship 3 means every course in the catalog is composed of many modules; and each module is incorporated in 1 or many courses. (*)
Relationship 4 means every module has many practice items. (*)
Relationship 5 means one course in the catalog is offered 0, 1, or many sessions throughout its life cycle.
Relationship 6 means one faculty has contributions to 0, 1, or many modules; and one module is developed by 1 or many faculties. (*)
Relationship 7 means one faculty has contribution to 0, 1, or many courses-sessions; and one course-session has contribution from 1 or many faculties. (*)
Relationship 8 means one course-session is composed of one or many modules; and one module is incorporated in many course sessions. (*)
Relationship 9 means one student has 0, 1, or many enrollment records. (*)
Relationship 10 means one course-session has 0, 1, or many enrollment records. (*)
Relationship 11 means one course-session has 1 or many scheduled exams. (*)
Relationship 12 means one scheduled exam has 1 or many exam-items.
Relationship 13 means one exam-item is drawn from 0, 1, or many practice items. (*)
Relationship 14 means one enrollment record has 0, 1, or many records of exam registration which may includes a grade. (*)
Relationship 15 means one scheduled exam has link to 0, 1, or many exam-registration-grade record.
Relationship 16 means one exam-item (sent to 1 or many graders) has 1 or many item-responses (from the graders) with assigned grade. (*)
Relationship 17 means one grader has 0, 1, or many item-response-grade records. (*)
Relationship 18 means one item-grade is calculated based on 1 or many item-response-grade records. (*)
Relationship 19 means the grade in one exam-registration-grade record is drawn from 1 or many item-grade records.
Relationship 20 means the average grade in a course-session is calculated from 1 or many exam-registration-grade record.
Relationship 21 means one record of faculty-performance may have the average grade for a course-session as part of his/her performance.
Relationship 22 means one faculty has many faculty-performance records.

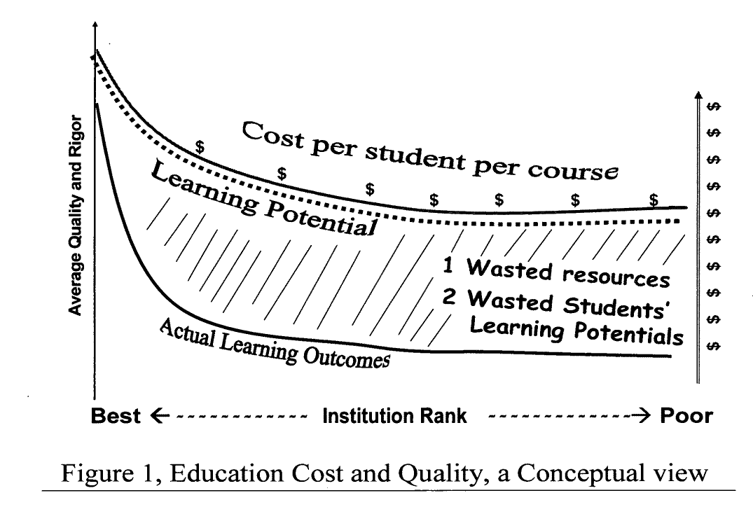

FIG. 1, the Actual Learning Outcome, the sum of Learning Potential, and Cost per Student per Course are plotted on subjective scales of Institution Rank and the Average Quality and Rigor of learning in various institutions. This figure visualizes two enormous wastes in the system: one is the wasted resources: the difference between the collective Actual Learning Outcome vs. the cost. The other waste is the difference between the actual vs. potential learning capabilities in students. At the top, some 5% or so, we have very high-quality-high-cost institutions. Below-that-top, the quality and rigor dive down drastically, but, the cost does not come down proportionally. This below-the-top majority of institution is the focus of MCMEd, which in this document, is referred to as ‘the present system,’ or ‘the present education.’

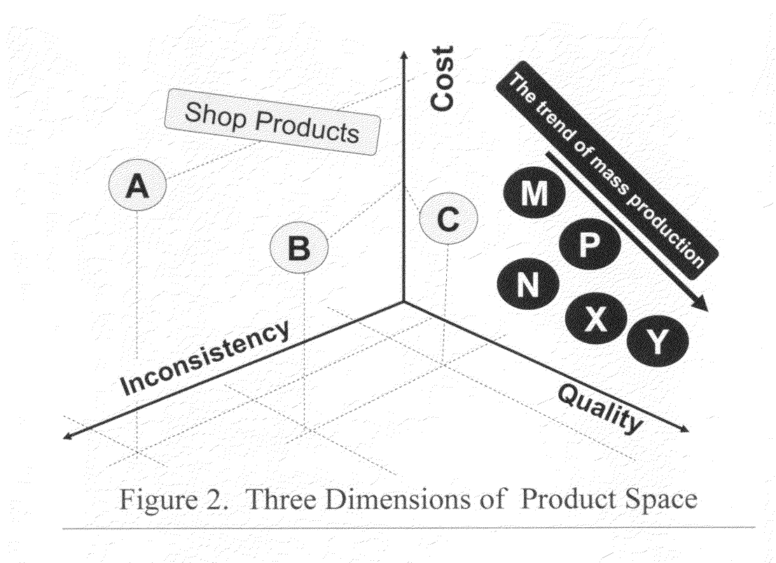

FIG. 2, in any production system, three variables are of prime importance: cost, quality, and consistency of the product. Consistency is the reverse of variability; for example, products B and C, may even have the same average cost and average quality, but B has a higher variability. In such cases, the deceptive marketing plays a bigger role in the success of the business than substance of the product—at the expense of the customers. The transformation of production from shops to the assembly lines reduced the cost, but more significantly, reduced the variability in the product quality. In time, what comes out of these assembly lines (M,N,P . . . X, Y products) are increasingly more consistent; therefore, the consumer has an easier decision making on the two dimensional Cost-Quality product space; and the producer has to compete within the two dimensional Cost-Quality product space.

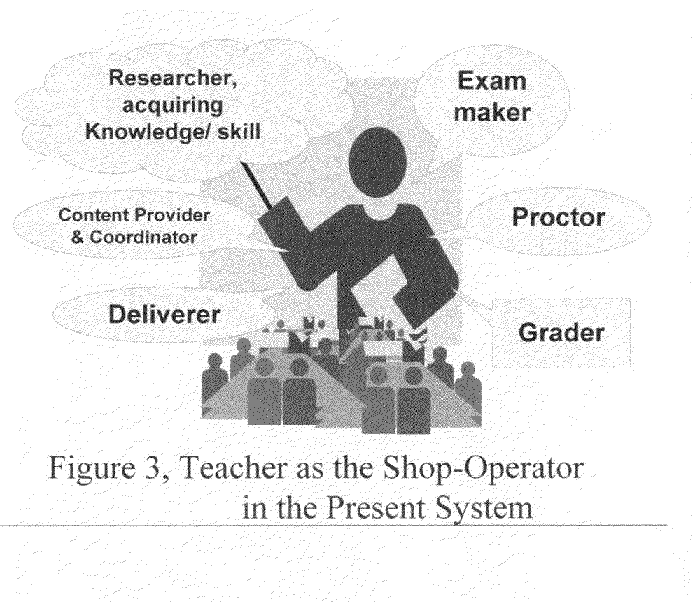

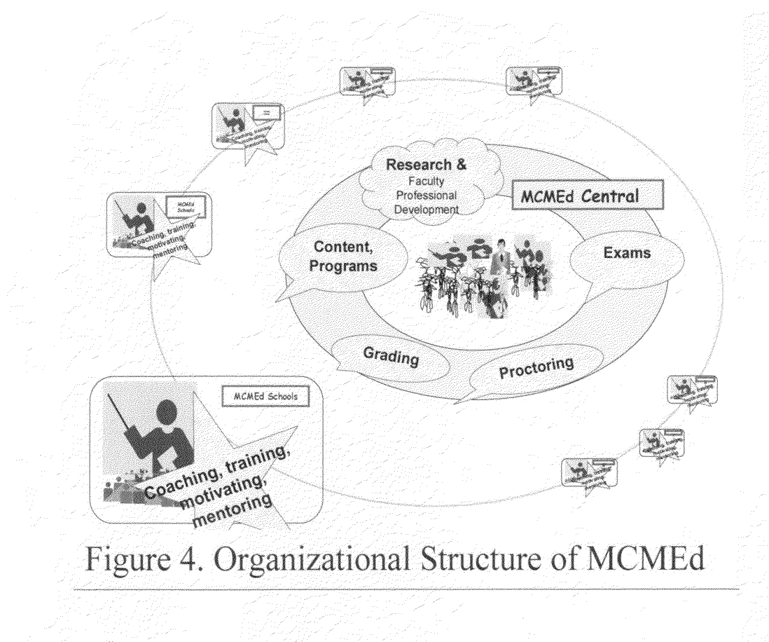

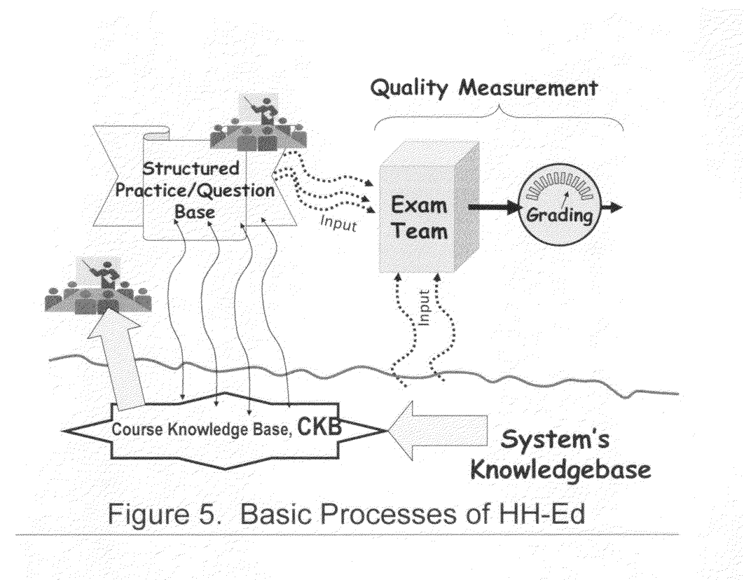

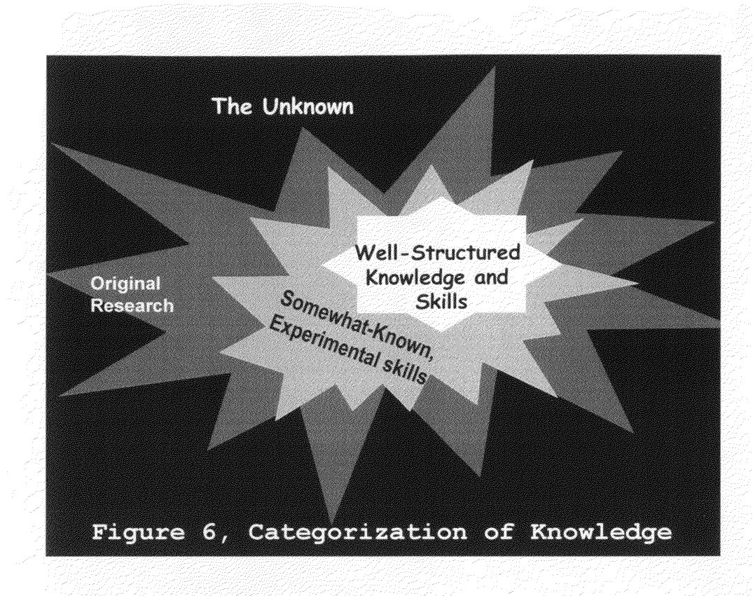

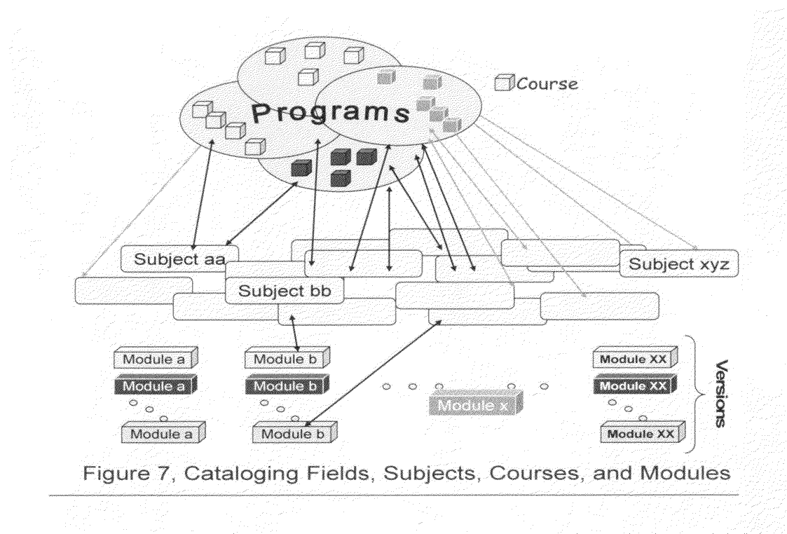

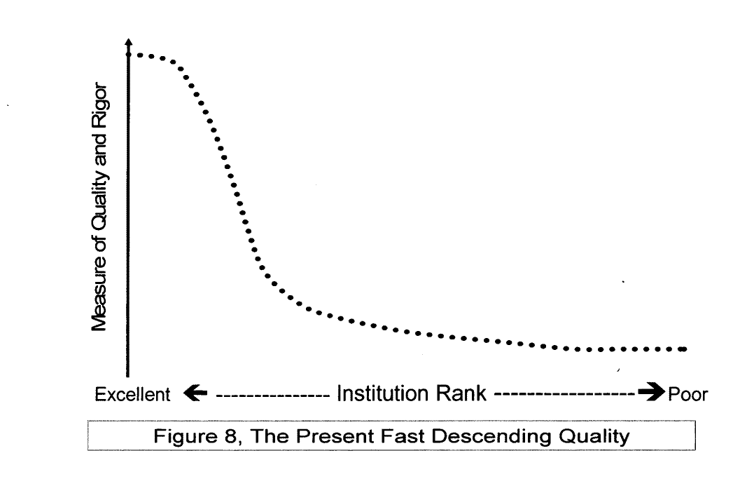

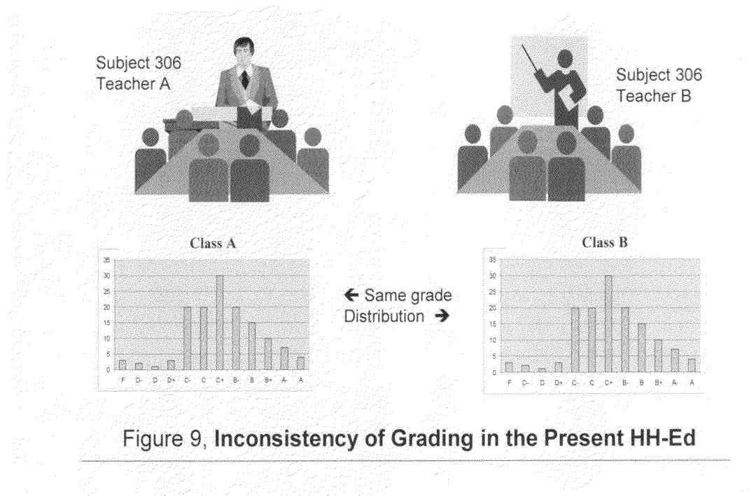

FIG. 3, In the present education system, the teacher develops delivers, manages a course, and then judges the learning outcomes of individual students by assigning grades. The teacher is, most often, the researcher, content provider, deliverer, exam maker, exam proctor, and the grader.

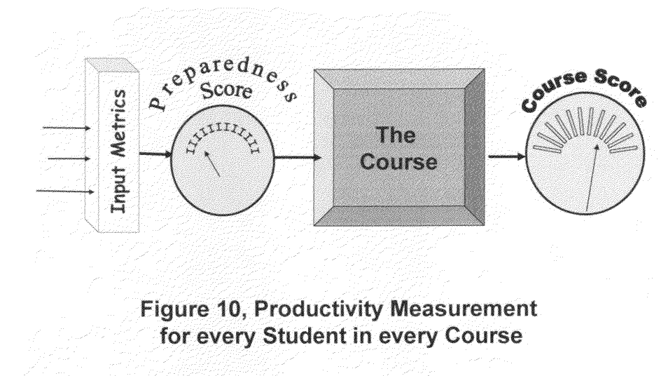

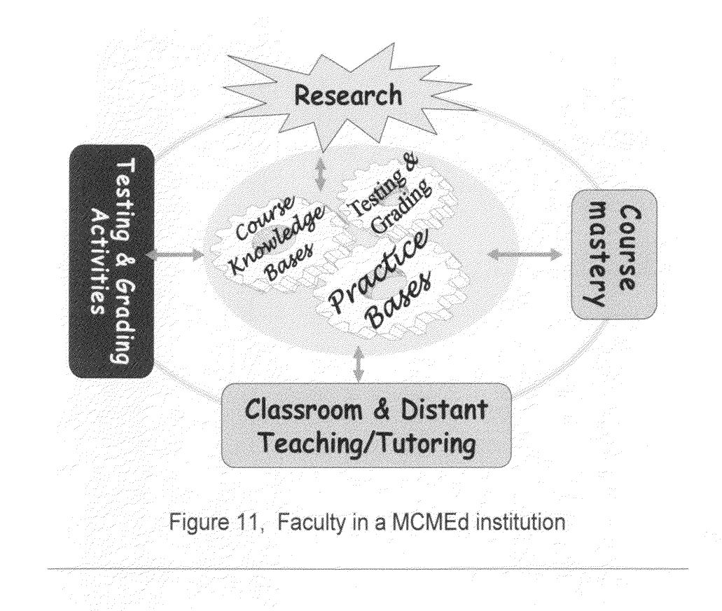

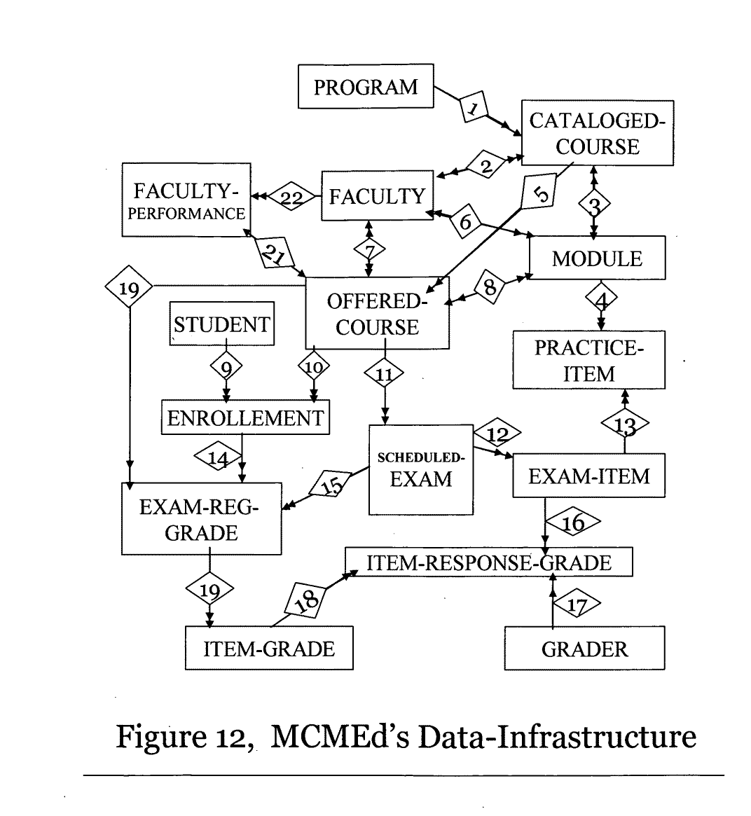

FIG. 4, the core in this figure represents the MCMEd Central, in which (a) teams of faculty do research and produce content in several format; (b) MCMEd'd intranet delivers the content; (c) teams of faculty make the exams and their assistants proctor exams; and (d) MCMEd's intranet sparse the responses and deliver them to the grading network and collects the scores and calculate the overall grade. Affiliated Schools are depicted as orbiting the MCMEd Central; they receive the content, deliver them to students, coach, train, and motivate the students, keep them on course, monitor their progress, and prepare them to take the course comprehensive exam.

FIG. 5, represents the following processes:
1. Extracting the Course Knowledge Base (CKB) from the broader well-structured System's Knowledge Base of interest to the institution.
2. Creating the related set of review questions, problems, analysis of cases, and/or design and development practices to foster active learning of the course content, the CKB. We refer to this set as “Practice Base, PB.
3. Delivering the content.
4. Guiding and coaching students' practices to learn the course content.
5. Creating and administering the quizzes and examinations; and
6. Evaluating each student's performances in the course and assigning a grade.

FIG. 6, three layers of knowledge are identified: The highest level knowledge is the most ambiguous layer, which is the subject of original research. The next layer is somewhat known, often experimental, knowledge and skills.’ The third layer is the well-structured knowledge and skills. The main struggle of human race is against the unknown. At the forefront of this struggle, first line researchers gradually bring pieces of the unknown into the somewhat-known. Doctoral research programs are designed to bring fresh troops into this frontier. Masters' degree programs are setup to bring pieces of somewhat known into known and often applicable territory. Finally, teachers and textbook authors make the known into well-structured knowledge to nurture high school and undergraduates learners.

FIG. 7, depicts the relationship of modules, subjects, courses, and programs in an education system. The relationship of Module and Subject is many to many; that is a subject is composed of one or more modules; and a module may be incorporated in more than one subject. The same (many to many) relationship exists between subjects and course, and between courses and programs.

FIG. 8, is a subjective depiction of fast descending quality and rigor as we come down on institution ranking. As we come down on the ranking curve, the enrollment pressure builds up.

FIG. 9, given two groups of students, comparable in background and ability, to two instructors to teach the same course, producing the same grade distribution for both groups, yet, one class may have covered several times more material and achieved more learning outcomes than the other class.

FIG. 10, measuring learning productivity requires that we have an Input Metrics (e.g. the average of the student's prior scores in all or selected courses) and two measurements: a Preparedness Score and Course Score of the student. The ratio of the Course Score over Preparedness Score is Student's Course Productivity Index (SCPI) which objectively measures the actual learning outcome. SCPI of 1 would be an expected value; above 1 will show better than expected; and below that 1 would indicate less desirable productivity.

FIG. 11, depicts the necessity of faculty rotation. In this figure the core shows the three basic products of the MCMEd Central: Course Knowledge Base, Course Practice Base, and Course Testing and Grading. These three must work consistently and congruently; therefore, the faculty members who are involved in these products must renew their research, their mastery over the courses, and their mastery over testing and grading. As well, they must be intimately in-touch with the learning process of students. To achieve such objective, faculty members are to rotate between these activities as well as among various academic teams

FIG. 12, is a simplified version of an Entity-Relationship Diagram which represents a minimum data infrastructure need for MCMEd. In addition to reflecting the data-model of MCMEd, the diagram also shows the integration of the education sub-systems in MCMEd. In this diagram, diamond shape symbols, with a number inside, refer to the relationships of the two data entities (sets of data) connected with arrows. The relationship marked (*) at the end are unique to MCMEd: others may be found in the present system as well. The meaning of each data relationship is as the following.
Relationship 1 means one program can have 0, 1, or many courses in the institution's catalog.
Relationship 2 means one faculty or one professional has qualifications and contributions to 0, 1, or many courses development; and every course is developed by many faculties.
Relationship 3 means every course in the catalog is composed of many modules; and each module is incorporated in 1 or many courses. (*)
Relationship 4 means every module has many practice items. (*)
Relationship 5 means one course in the catalog is offered 0, 1, or many sessions throughout its life cycle.
Relationship 6 means one faculty has contributions to 0, 1, or many modules; and one module is developed by 1 or many faculties. (*)
Relationship 7 means one faculty has contribution to 0, 1, or many courses-sessions; and one course-session has contribution from 1 or many faculties. (*)
Relationship 8 means one course-session is composed of one or many modules; and one module is incorporated in many course sessions. (*)
Relationship 9 means one student has 0, 1, or many enrollment records. (*)
Relationship 10 means one course-session has 0, 1, or many enrollment records. (*)
Relationship 11 means one course-session has 1 or many scheduled exams. (*)
Relationship 12 means one scheduled exam has 1 or many exam-items.
Relationship 13 means one exam-item is drawn from 0, 1, or many practice items. (*)
Relationship 14 means one enrollment record has 0, 1, or many records of exam registration, which may includes a grade. (*)
Relationship 15 means one scheduled exam has link to 0, 1, or many exam-registration-grade record.
Relationship 16 means one exam-item (sent to 1 or many graders) has 1 or many item-responses (from the graders) with assigned grade. (*)
Relationship 17 means one grader has 0, 1, or many item-response-grade records. (*)
Relationship 18 means one item-grade is calculated based on 1 or many item-response-grade records. (*)
Relationship 19 means the grade in one exam-registration-grade record is drawn from 1 or many item-grade records.
Relationship 20 means the average grade in a course-session is calculated from 1 or many exam-registration-grade record.
Relationship 21 means one record of faculty-performance may have the average grade for a course-session as part of his/her performance.
Relationship 22 means one faculty has many faculty-performance records.

We claim:

1. A new institutional level Business Method, which facilitates mass production/customization of High School and Higher Education.

2. The method as in claim 1 for achieving mass production is by identifying the repetitive tasks in the core learning process, and restructuring of the said process.

3. The method as in claim 2, the elements of the core learning process is the work of the teacher in the present shop-mode educational operation, which consists of: (a) preparing the course content, including the related set of review questions, problems, analysis of cases, and/or design and development practices; (b) delivering the course content; (c) guiding and coaching students' practices to learn the course content, and achieve their maximum potential; (d) creating and administering the quizzes and examinations; and (e) evaluating each student's performance in the course and assigning a grade; and (f) maintaining qualifications for the above items by being engaged in research and/or acquiring needed knowledge and skills.

4. The method as in items (a), (b), and (d) of claim 3, a MCMEd centralized business structure is devise to capture, centralize, consolidate, and coordinates the repetitive content and tasks and makes the results available through computer output.

5. The method as in item (c) of claim 3, a distributed set of MCMEd affiliated schools is devised to facilitate tasks that can not or should not be computerized and need personalized attention, in particular, (i) laboratory work that, beyond virtual lab practices, must be done in physical labs; and (ii) instructors' full attention to the needs of individual or groups of students to maximize their learning potential.

6. The method as in claim 4, and in relation to item (a) of claim 3, the subject and content of learning in high school and in course work of higher education can be captured, centralized, and make reusable, because they are within the spectrum of well-structured knowledge and skills.

7. The method as in claims 4 and 6, and in relation to item (a) of claim 3, MCMEd utilizes the significant overlaps that exists between the content of different courses at HH-Ed levels, and structures the content of the knowledge base of interest to the institution into modules, and thus promotes reusability of the knowledge objects.

8. The method as in claims 7, the content of each course is extracted, assembled, and customized from the modules within the larger knowledge base of interest to the institution.

9. The method as in claims 4, and 8, and in relation to items (a) and (b) of claim 3, development of a Course Knowledgebase, CKB, goes through two stages: (i) producing course modules, that are not already in the knowledgebase of the institution, in various reusable formats (e.g. video of the lectures, question/answers, debate; computer text, graphics, animation, simulation, games, and references to printed material) and alternative pedagogical styles as appropriate to the subject; and (ii) customizing each course by assembling course-modules tailored to the subject.

10. The method as in claims 9, in relation to items (a) and (b) of claim 3, in conjunction with the CKB, constructing a Practice Base, PB, is devised to achieve active learning, where PB is a database which includes: (a) Selected Response or so called objective questions/practices, e.g. Multiple-Choice, True/False, Filling-the-Blank, (b) subjective questions/practices, e.g. essay, problems, cases, simulation, debate, role-play, games, etc., and (c) guides, hints, suggestions, templates, samples, and/or actual solutions.

11. The method as in claims 4, 9 and 10, in relation to item (a) and (b) of claim 3, producing and updating of the CKB/PB(s) as well as academic/professional programs and curriculums are performed in the MCMEd central unit; the products then become available to the MCMEd affiliated schools for delivery to individual students, as well as to physical and/or virtual classrooms trough compute output.

12. The method as in claim 5, and in relation to item (c) of claim 3, advising, guiding, coaching, mentoring, and motivating functions of the instructors are preformed through the MCMEd affiliated schools, where (i) students receive timely advises on program and course selections, (ii) instructors and tutors keep students on-course by conducting practices on the modules in the CKB/PB, and conducting non-binding quizzes and tests available in the CKB/PB as well as those added by the instructor all aimed at the comprehensive final test for the course, and (iii) under diagnostic observations of advisors, instructors, and tutors, individual's learning obstacles are identified and remedies are pursuit.

13. The method as in items (d) of claims 3 and 4, creating the binding comprehensive final test for each course is performed by a team of Faculties at the MCMEd central unit, and independent of the instructors who coached the course at the affiliated schools.

14. The method as in items (d) of claims 3 and 4, conducting (proctoring) the binding comprehensive final test for each course is performed at a test center (security-fortified computer lab inside or outside of MCMEd Affiliated schools) but administered by the MCMEd central unit independent of the instructors who coached the course at the affiliated schools.

15. The method as in items (e) of claims 3, anonymous grading of the binding comprehensive finals for the course is performed by a grading network administered by MCMEd central unit independent of the instructors who coached the course at the affiliated schools.

16. The method as in claim 15, objective items in the test are graded by the computer; subjective items tests are graded in single-round or double-rounds grading by the academic personnel in the grading network; such personnel would grade laboratory and performance competencies as well.

17. The method as in claim 16, the following double-rounds grading procedure is devised to enhance the reliability of grading subjective items in the test: students' responses to items are dispersed to the network of graders; each response to each question is sent to two graders; each grader receives the response on a web page in the institution's intranet with grading criteria and structure, which facilitate the speed and consistency of grading; the two graders send the assigned grades to the grading database; if the assigned grades are close, as determined by the criteria set by the test-maker teams and imbedded in the database, the average points will be the judgment; if not, the response will be assigned to the third grader and beyond, until consistency of grading is established.

18. The methods as in claim 14, student responses are time-stamped, measuring student' professional agility for which he/she receives an Agility Index (AI) on the transcript alongside the course grade.

19. The method as in claim 1 for Total Quality Management (TQM) includes (a) student's course productivity, (b) course productivity at each class in each affiliated school, (c) evaluation of each instructor's performances, (d) productivity of each affiliated school, and (e) audit control of the MCMEd institution.

20. The method as in item (a) of claim 19, learning productivity index is the objective measurement of each student's actual learning outcome in a particular course, defined by output over input; thus Student's Course Productivity Index (SCPI) is calculated by student's grade in that course over his/her preparedness index before entering the course, where preparedness index is taken from students Grade Point Average in all or selected prerequisite courses,

21. The method as in item (b) of claim 19, Course Productivity Index (CPI) measures the actual learning outcome in a course session in an affiliated school, calculated by averaging students' SCPIs in that course.

22. The method as in item (f) of claim 3, support for faculties development is the responsibility of the MCMEd central unit, where availability and utilization of needed resources, as well as opportunities for academic and professional interactions are optimized.

23. The method as in item (c) of claim 19 and claim 12, a faculty's instructional performance in a particular course as well as for an academic cycle is objectively measured by respective average CPIs.

24. The method as in item (c) of claim 19, evaluation of a faculty's performances in non-instructional duties are subjective and performed through peer and administrative reviews on duties which include contributions to: (i) research, (ii) CKB/PB(s) development and feedbacks, (iii) Tutorial/Helpdesk system, (iv) learning diagnostic and remedies, and (v) system diagnostic, and in particular feedback on course structure, curriculum, and programs.

25. The method as in item (d) of claim 19, the learning productivity of each affiliated school, SP, is the average of CPI for all course sessions offered during a period at that school. SP objectively measures school's performance in mobilizing the students and faculties toward a higher learning outcome.

26. The method as in item (e) of claim 19, audit control of the MCMEd institution is periodic subjective evaluation of the quality of all CKB/PB(s), exams, grading system, curriculum and programs, and research as well as identification of the system's actual and/or potential flaws, by a recognized independent assessment and accreditation body.

27. The method as in claim 1 is supported by a data structure) as in the diagram depicted on FIG. 12 and explained on page 49.
